(19) United States
(12) Patent Application Publication
(10) Pub. No.: US 2006/0112049 A1
(43) Pub. Date: May 25, 2006

(54) Generalized branching methods for mixed integer programming

(76) Inventors: Sanjay Mehrotra, Winnetka, IL (US); Zhifeng Li, Cary, NC (US)

Correspondence Address: Mr. Edward J. Timmer, P.O. Box 770, Richland, MI, 49083-0770, US

(21) Appl. No.: 11/239,645

(22) Filed: Sep. 29, 2005

Related U.S. Application Data
(60) Provisional application No. 60/614,185, filed on Sep. 29, 2004.

(51) Int. Cl. G06N 5/02

(52) U.S. Cl. 706/46

(57) ABSTRACT

A method and system using branching on hyperplanes and half-spaces computed from integral adjoint and/or kernel or dual lattice basis for solving mixed integer programs within specified tolerance. It comprises steps of: (1) preprocessing to ensure feasibility and linear objective; (2) computing adjoint and/or kernel lattice basis of the equality constraint coefficient matrix, or its transformed sub-matrix; (3) generating a generalized-branch-and-cut tree; (4) selecting a node and adding new constraints or approximating existing constraints; (5) processing a node to update lower and upper bounds, deleting nodes, or removing variables; (6 optional) computing an ellipsoidal approximation of continuous relaxation of (5); (7 optional) computing new lattice basis; (8) partitioning the set in (4) generating two or more nodes; (9) repeating (5-8) till termination. Such can be applied to problems in marketing management, data mining, financial portfolio determination, product design optimization, and other complex systems where optimization of system is desired.

### RELATED APPLICATIONS

This application claims the benefit of priority of U.S. provisional application Ser. No. 60/614,185, filed Sep. 29, 2004, which is incorporated herein by reference.

### STATEMENT REGARDING FEDERALLY SPONSORED RESEARCH OR DEVELOPMENT

The present invention was funded under federal demonstration grants from the National Science Foundation (NSF) grant number DMI-0200151 titled Generalized Branch and Cut Methods for Mixed Integer Programs, and Office of Naval Research (ONR) grant number N00014-01-1-0048 titled Methods for Linear and Mixed Integer Programs. Sanjay Mehrotra was the sole principal investigator on both grants. The abstract of the proposal for these grant follows.

### FIELD OF THE INVENTION

The present invention relates generally to the field of mathematical programming and optimization, and more particularly to generalized branching methods and computing systems for mixed integer programming.

### BACKGROUND OF THE INVENTION

In recent years mathematical programming approaches for modelling complex business, engineering and data analysis problems have been widely explored to find optimum or near-optimum decisions (solutions) that are otherwise not possible to identify. These models consist of plurality of decision variables whose best value is desired. The mathematical programming models take the form of an objective that is described with a mathematical function, and a set of constraints also described by mathematical functions. The plurality of decision variables are put in the form of a vector, and the functions defining the objectives and constraints are multi-dimensional, i.e., they evaluate a multi-dimensional vector. An important class of mathematical programming models are mixed integer programming models. The functions describing the objective and constraints may be linear, or differentiable as well as non-differentiable convex functions. Furthermore, some or all of the decision variables take integer values only, while other may take any value on the real line provided that other constraints are satisfied.

For any application model there are an infinite integer programming problems. Each particular problem is called an instance. An instance is given by specifying the mathematical structures of the functions and assigning numerical values to the parameters in the problem. The input data that specify an instance includes the number of integer variables n, the number of continuous variables \overline{n}, the number of linear equality constraints m+\overline{m}, and the number of convex inequality constraints l. Each linear and convex equality and inequality constraints have a right hand side, which is a constant. For convex inequality functions no generality is lost if the right hand side is set to 0, and the constant is taken on the left hand side. Furthermore, the input data of an instance includes the mathematical structures and the numerical values of all parameters in each function. The mathematical structure of each function may be explicitly available at the beginning, or they may be available only implicitly and either their form or the form of an approximation of these functions is revealed during the computation as a part of a bigger system. If the functions are only available implicitly the method providing information on the function is called an oracle. The data set describing linear equality constraints is placed in the form of a matrix, known as the equality constraint coefficient matrix. The data set describing convex constraints is stored using a suitable storage scheme.

The goal of a computing system for mixed integer programming is to find a solution that is within a pre-specified tolerance of the best solution, while also satisfying all the constraints within a pre-specified tolerance—or—claim that no feasible solution exists. This computing system comprise of a method (algorithm) with method steps (possibly consisting of methods themselves) that use a combination of strategies to efficiently find a desired solution. An algorithm for finding a solution of a mixed integer programming problem is a systematic procedure which can work on any instance an find a solution in a finite number of steps. On any given instance, the execution of an algorithm consists of a finite number of elementary arithmetic operations, which are addition, subtraction, multiplication, division, and comparison. The efficiency of the computing system is important, since an inefficient computing system may not be able to generate a desirable solution in a reasonable amount of time.

This branch-and-cut method combines two major methods, namely the branch-and-bound method and the cutting-plane method. The first method generates a branch-and-bound tree. The branch-and-bound method was originally developed in 1960s. For the moment consider a pure 0-1 integer programming problem
minimize the objective Σᵢ₌₁^{k}cᵢxᵢ
satisfying constraints Σᵢ₌₁ⁿxᵢAᵢ=a, xᵢ=0 or 1, for i=1, . . . n (1)

Here the symbol Σ indicates the summation of quantities following the symbol over the arguments used as subscript and superscript of the symbol. The symbol Aᵢ represents the ith column vector having m elements, a is a column vector having m elements, and xᵢ are decision variables which are allowed to take only two values zero or one, and the vector equality describing the constraints is required to hold component-wise.

The number of possible solutions in the pure binary integer program (1) is finite. A naive attempt to find the combination of xᵢ that will find a solution for which the objective takes the smallest possible value among the set of solutions that satisfy all the constraints will enumerate all possible combinations of values of xᵢ. A problem with 100 variables has 2¹⁰⁰ possible combinations. For a supercomputer that examines one trillion solutions per second, it would still need four million years to check all possible candidate solutions. Complete enumeration is not efficient because it ignores the information generated while doing the enumeration. Branch and bound uses a partial enumerative strategy in which by fixing the integer variables one by one, an enumerative tree can be established level by level. For problem (1) there are only two choices (zero or one) to fix xᵢ, hence each time a variable is fixed two problems with one fewer variable are generated. The problem generating these subproblems are called parent, and the generated problems are called children. The original problem is called the root problem. The organization of all these problems is called a branch-and-bound tree.

Certain rules are followed to eliminate nodes in the branch-and-bound tree. If a node is infeasible, then we know that all its children nodes are infeasible and they can be eliminated together with this node. Similarly, if the objective value at a nodes has exceeded the minimum objective value, then this node together with its children may also be eliminated.

To check if the objective value at a node will exceed the minimum objective value, a upper bound is maintained. This upper bound is computed from a feasible solution available thus far in the algorithm, otherwise it is set to infinity. For example, if the minimum objective value in problem (1) obtained after relaxing the restriction on all the decision variables from xᵢ=0 or 1 to 0≦xᵢ≦1 (called continuous relaxation) is greater than the current best upper bound, this node will never find a solution with an objective value smaller than the upper bound, hence it may be deleted and its children are not generated. Only nodes with have the possibility of generating a better solution are maintained in the branch-and-bound tree. At each node of the branch-and-bound tree we need to decide which variable to branch one. This is usually done by some branching rules that select one among the variables that are fractional at an optimum solution of the relaxed problem. The branch-and-bound strategy stops when no nodes are left in the tree for further processing.

A mixed integer convex programming problem is given by:
minimize the objective c₀(x)
satisfying constraints Σᵢ₌₁xᵢRᵢ=r, i=1, . . . , n+\overline{n},
xᵢ is integer for i=1, . . . , n, cᵢ(x)≦0, for i=1, . . . , l (2)

In the problem (2) the first n decision variables xᵢ are restricted to take integer variables, while variables n+1, . . . , n+\overline{n} may take any continuous value provided that other constraints in the problem are satisfied. There are n+\overline{n} column vectors Rᵢ, and equations Σᵢ₌₁ⁿxᵢRᵢ=r are also written as Rx=r using the matrix notation. Here Rx is the product of vector x with matrix R. The standard branch-and-bound technique just described for the pure 0-1 programming problem extends to the mixed integer programming problems as follows. The computational logic of the branch-and-bound method for mixed integer programming is illustrated in the flow chart of FIG. 1 for the general setting of mixed integer convex programming problems. The original problem is labelled the root node of the tree. A continuous relaxation of the problem at a chosen node of the branch-and-bound tree is solved. If the continuous relaxation problem is infeasible then this node is deleted and its children are not generated. If the continuous relaxation problem is feasible but has an objective larger than the upper bound, this node is deleted and its children are not generated. If the optimum solution of this problem satisfies the integrality restrictions, then we check if its objective value is lower than the current upper bound, in which case we update the upper bound and keep this solution as a candidate optimum solution. Finally, if the continuous relaxation is feasible but has fractional solutions then we pick one of the variables taking fractional value at the optimum. Assume that this variable is represented by xᵢ (1≦i≦n), and the corresponding value is xᵢ*. Then two constraints (half-spaces) of the form xᵢ≦└xᵢ8┘, and xᵢ≧┌xᵢ*┐ are generated, which are added to the constraints of the current node to generate its two children obtained respectively. The generation of the children in this way is called single variable branching. Here └xᵢ*┘ denotes the largest integer smaller than or equal to xᵢ*, and ┌xᵢ*┐ denotes the smallest integer larger than xᵢ*.

The second method uses the observation that the efficiency of the branching process may be improved by finding tighter represented on the convex hull of feasible solutions to the mixed integer programs. Since we do not know the solutions of mixed integer programs, in the 1980s (Nemhauser, et al. 1988) and 1990s (Wolsey, 1998) extensive development took place for finding methods for generating tighter representations by taking advantage of information available in the constraint system. The generation of tighter representation of the convex hull of mixed integer problems is achieved by adding new linear and convex constraints to the original set of constraints. These constraints are called cuts, of these cuts the linear cuts are the most important. Among the techniques for generating cuts, the Chvatal-Gomory cuts and the disjunctive cuts are most popular. The cuts generated in this way are often further strengthened by taking advantage of the coefficient properties (mixed integer rounding) of the cuts (Wolsey, 1998). When the branch-and-bound strategy is combined with cutting plane generation, the resulting method is called branch-and-cut method.

The number of nodes generated in the branch-and-cut tree are critical in our ability to solve the mixed integer programming problem. This number depends on the rule used to select a variable for branching, and the node of the branch-and-bound tree selected for further processing. Among the popular rules for branching variable selection are the most fractional variable rule, and the strong branching rule. The strong branching rule tries to get additional information on the impact of branching on a variable before choosing it for branching in the algorithm. It is known to save significant computational effort over most fractional variable strategy (Wolsey, 1998). It is also well known that for mixed integer programming problems, where variables are allowed to take general integer value, the branching rules based on single variable branching can produce a branch-and-bound tree in which the number of nodes are exponential in the amount of storage needed to save the problem data. This indicates that for difficult mixed integer programs, a rule that branches on a fractional variable (most fractional or strong branching rule), may be very inefficient (Wang 1997). In fact, there are examples of problems with only few variables where state of the art solvers fail because the number of nodes in the branch-and-bound tree they generate becomes too large. Lenstra (1983) developed an algorithm for mixed integer linear programming (where the objective and constraints are linear functions) and showed that in this method the number of nodes in the branch-and-bound tree are not exponential in the amount of storage needed to save the problem data. A central aspect of Lenstra's algorithm is the use of a general hyperplane (instead of a variable) for branching. The class of algorithms that are designed to allow branching on a general hyperplane (or half-space) are called generalized-branch-and-bound algorithms. Lenstra (1983) algorithm assumes that the original problem is described over a full dimensional set. Then as described in Schrijver (1986), at every node of the branch-and-bound tree it performs four basic steps: (i) Ellipsoidal rounding of the set; (ii) a lattice basis reduction in an ellipsoidal norm; (iii) Feasibility check; (iv) dimension reduction of the set. Lattice basis reduction is at the core of the overall construction, and the algorithm of Lenstra, Lenstra, and Lovász (1982) is used for this purpose.

The generalized-branch-and-bound algorithm by Lovász and Scarf (1992) for mixed integer programming is related to Lenstra's algorithm with the important difference that it does not require an ellipsoidal rounding of the feasible set. Wang (1997) developed this algorithm further for mixed integer convex programs, and gave a growing search tree algorithm removing an earlier requirement of bisection search in Lenstra's algorithm. The lattice basis reduction is Lovász and Scarf (1992) algorithm is done using a generalized basis reduction method also given in Lovász and Scarf (1992). Each iteration of the generalized basis reduction algorithm requires solutions of mathematical programs to compute a generalized norm defined over a convex set. The number of iterations in the generalized basis reduction algorithm are polynomial in fixed dimension. These two properties of the generalized basis reduction algorithm make it potentially expensive. Despite its theoretical shortcomings the generalized basis reduction algorithm is an important alternative to using Lenstra, Lenstra, and Lovász (1982) (or related) basis reduction methods when reducing a lattice basis for solving integer programming.

One major stumbling block in the computational efficiency of Lenstra's generalized-branch-and-bound algorithm, and the Lovász-Scarf generalized-branch-and-bound algorithm is the assumption that the continuous relaxation of the problem at each node of the generalized-branch-and-bound tree has a nonempty interior. All previous theoretical and computational research on this algorithm has worked under this assumption. For example Cook, et al. (1993) implemented Lovász-Scarf generalized-branch-and-bound algorithm for solving mixed integer linear programming problems. Cook, et al. (1993) assumed full dimensionality of problems, and they transformed data in the original constraint matrix in order to record unimodular operations in generalized basis reduction algorithm. Cook, et al. (1993) solved several difficult mixed integer problems and found that the number of nodes in the branch and bound tree were significantly fewer than those present in the standard approach that branches on one variable at a time. Moreover, the overall computational performance was better on several difficult problems in comparison with the CPLEX mixed integer programming solver (CPLEX) available at the time. Wang (1997) presented a refinement of the algorithm implemented by Cook, et al. (1993). In particular, he replaced the bisection search with a more refined growing tree approach, and solved several convex integer programs using the generalized-branch-and-bound algorithm, where generalized basis reduction algorithm was used to generate branching hyperplanes. Gao, et al. (2002) reported their experience with implementing Lenstra's algorithm where ellipsoidal rounding was used for finding the branching hyperplane. They also performed dimension reduction at root and other nodes in the generalized-branch-and-bound tree to maintain full dimensionality of the polyhedral set. The ellipsoidal rounding was obtained by computing a maximum volume ellipsoid approximating the polyhedral set using an interior point method. In a sequence of papers Aardal, et al. (1998, 2000, 2002, 2004) proposed and studied a reformulation technique for pure integer linear problems using kernel lattices. Computationally they showed that branching on single variables in the reformulated problem requires significantly fewer branches than those required to solve the original problem for some difficult integer linear programs. Their reformulation of the problem also generates a full dimensional problem using a Lenstra, Lenstra, and Lovász reduced kernel lattice basis. Owen, et al. (2001) heuristically generated the branching disjunctions (where at each node only two branches are generated) at the optimal solution and reached conclusions very similar to those reported in the work of Cook et. al. (1993). The interesting aspect of the results in Owen, et al. is that the hyperplanes are not generated from the minimum width hyperplane finding problem; instead they are generated from the desire to improve the lower bound on the objective value as much as possible.

A second stumbling block in the computational efficiency of generalized-branch-and-bound algorithms is that the computational effort required in the computing a reduced lattice basis. The work in Cook, et al. (1993), Wang (1997), and Gao and Zhang (2002) computes the reduced lattice basis at every node of the generalized-branch-and-bound tree. Although the work in Aardal et al. (1998, 2000, 2002, 2004) propose to perform this lattice basis reduction only at the root node, a reformulation of the problem is proposed. Furthermore, the work only applies to the pure linear integer programming problems.

No previous work has considered generation of cutting planes at the nodes of a generalized-branch-and-bound tree, or the possibility of developing a generalized-branch-and-cut algorithm.

Mixed integer programming finds real-world, practical or industrial applications in many situations. These applications arise in a marketing management, data mining, financial portfolio determination, design optimization, and other complex systems where optimization of system is desired.

An example of a problem in marketing management is the market split problem (Cornuéjols, et al. (1998). A company with two divisions supplies retailers with several products. The goal is to allocate each retailer to one of the divisions such that division 1 controls 100αᵢ% of the market share, and division 2 controls the remaining 100(1−αᵢ)% market share. Here 0≦αᵢ<1. There are m retailers and n≦m products. Let a_{i,j} be the demand of retailer j for product i, and let dᵢ be determined as └αᵢd′ᵢ┘, where d′ᵢ is the amount of product i that is supplied to the retailers. The decision variable xⱼ takes value 1 if retailer j is allocated to division j, and zero otherwise. The problem is to decide an allocation of the retailers to the divisions such that the desired market split is obtained.

An example of mixed integer programming problem arising from biological data mining is in Thomas, et al. (2004). In this problem we are interested in whether we can infer a set of possible genetic regulatory networks that are consistent with observed expression patterns. The data that is used to identify the network is obtained from simulation of a model of a gene network, which corresponds to data obtained from DNA5 microarray experiments.

In the financial portfolio determination problem an investor is interested in maximizing his return on the investment in the portfolio of assets (stocks, bonds, real-estate), while taking as little risk as possible. The integer requirements in the model appear (Wang 1997) when we bound the maximum number of assets to be selected in the portfolio, or if there is a fixed cost of investing in an asset that would incur regardless of the amount of investment in that asset.

An example of a design problems is the problem of designing a cellular network (Mazzini (2001)). The cellular telecommunication network design aims to define and dimension the cellular telecommunication system topology in order to serve the voice and/or data traffic demand of a particular geographic region. The problem is to decide the base station location, the frequency channel assignment problem and the base station connection to the fixed network in a cost effective manner.

### SUMMARY OF THE INVENTION

The disadvantages and limitations of the background art discussed above are overcome by the present invention. With this invention, an improved method and a computing system for finding a solution of the mixed integer programming problem within a desirable accuracy is provided. This method and computing system of present invention uses method steps that generate a generalized-branch-and-cut tree requiring no problem reformulation, and adding branching hyperplanes and half-spaces in the space of original variables. The present invention is based on a new concept of integral adjoint lattices, and the concepts of kernel and dual lattices. The present invention no longer requires a problem reformulation to remove continuous variables from a mixed integer problem. The present invention no longer requires the continuous relaxation of the pure integer program to be full dimensional. The present invention also provides a method for rounding points in the feasible region to heuristically generate a feasible point and an upper bound on the mixed integer program. The present invention also provides a new method for generating cutting planes using disjunctive programs defined from using an integral adjoint lattice basis vectors. The present invention also integrates the use of barrier functions to identify a log barrier analytic center, or Vaidya volumetric center, and a positive semidefinite matrix to describe an approximation of the continuous relaxation of the feasible set.

Briefly, a computer embodiment of the present invention determines a solution of a mixed integer program to a desired precision. The computing system generates a generalized-branch-and-cut tree whose nodes are processed, added, and removed using certain method steps. The information on generating a branching hyperplane or half-space, cutting planes, and rounding of solutions is computed using an integral adjoint lattice or kernel or dual lattice basis of the coefficient matrix corresponding to the equality constraints.

The method comprises steps of: (1) generating a generalized-branch-and-cut tree. This tree consists of root and children nodes. The root and children nodes comprise of a mixed integer program, whose generation is described below. Method steps (2-7) are performed at the root node, and method steps (6-10) are performed until there is no node left in the generalized-branch-and-cut tree; (2) computing an exact or approximate kernel lattice basis and/or its integral adjoint lattice basis and/or dual lattices corresponding to the equality constraint coefficient matrix, or a transformed sub-matrix of the equality constraint coefficient matrix. The integral adjoint lattice or kernel basis or dual basis are stored in a matrix consisting of vectors; (3) if desired making the objective in the problem linear by bringing the original objective as constraint; (4) adding a new variable with a suitably large penalty to ensure feasibility; (5) identifying an available node for processing and adding new linear and convex constraints and/or approximating existing convex constraints with linear constraints while preserving the solution set of the original problem. The new constraints may be generated from disjunctive programs defined using lattice basis vectors, or by linearlization of the convex constraints; (6) ignoring the integrality requirement to generate a continuous relaxation of the problem associated with the node; (7) solving the continuous optimization problem to possibly generate a new lower bound, or delete the problem at the node because the system can claim that this node will not produce a better solution, or delete one or multiple variables from the problem because the system can claim that these variables are now known; (8a optional) finding a point w and a new matrix Q describing a suitable ellipsoidal approximation of the set of feasible solutions in (6); (8b) Processing the information on the node further by rounding analytic center or other feasible solution of problem in (6) to identify a feasible solution of the mixed integer program and updating the upper bound; (9) starting from an available exact or approximate adjoint lattice basis or kernel lattice basis or dual lattice basis find a new exact or approximate adjoint or kernel or dual or all three lattice basis whose basis vectors satisfy known conditions on their lengths. The lengths are defined using the set in (6), or its approximation in (8), or some other suitable approximation; (10) Using vectors from the lattice basis in (9) divide the set in (6) into two or more subsets while ensuring that the solution of (4) are contained in the union of these sets; (10) for the problems generated in (9) and repeat steps (5)-(8). When repeating steps (6)-(8) re-computation of a new integral adjoint or kernel lattice basis in (7) is optional and follows a hierarchical decision process to decide when to perform new basis reduction and how to use the existing basis. Such can be applied to problems in data mining, financial portfolio optimization, marketing campaign optimization, device and product design optimization, and other complex systems where optimization of the system is desired.

It may therefore be seen that the present invention overcomes the shortcomings of the present art, and provides a new and novel method and computing system for solving mixed integer programming using a generalized-branch-and-cut tree, while generating branching hyperplane or half-spaces, and cutting planes, from integral adjoint lattice or kernel lattice bases of the coefficient matrix corresponding to the equality constraints.

### DESCRIPTION OF THE DRAWINGS

These and other advantages of the present invention are best understood with reference to the drawings, in which:

FIG. 1 is a flow chart of simple branch-and-bound algorithm

FIG. 2 is an outline of the Lenstra, Lenstra, Lovász lattice basis reduction algorithm using a projection or ellipsoid norm

FIG. 3 is an outline of the Lovász-Scarf generalized lattice basis algorithm

FIG. 4A is a flow chart of Lenstra's algorithm, which is continued on FIG. 4B

FIG. 4B is a flow chart of Lenstra's algorithm, which is a continuation from FIG. 4A

FIG. 5 is a schematic description of branching process in Lenstra's algorithm

FIG. 6A is a flow chart of Lovász and Scarf algorithm as Given in Wang 1997, which is continued on FIG. 6B

FIG. 6B is a flow chart of Lovász and Scarf algorithm as Given in Wang 1997, which is a continuation from FIG. 6A which is continued on FIG. 6C.

FIG. 7 is a schematic description of growing tree branching process.

FIG. 8A is a flow chart of the a preferred embodiment of the generalized-branch-and-bound version of the present invention for Pure Linear Integer Programming Computing System, which is continued on FIGS. 8B, 8C and 8D.

FIG. 8B is a flow chart of the a preferred embodiment of the generalized-branch-and-bound version of the present invention for Pure Linear Integer Programming Computing System, which is a continuation of FIG. 8A, and continued on FIGS. 8C and 8D

FIG. 8C is a flow chart of the a preferred embodiment of the generalized-branch-and-bound version of the present invention for Pure Linear Integer Programming Computing System, which is a continuation of FIGS. 8A and 8B, and continued on FIG. 8D

FIG. 8D is a flow chart of the a preferred embodiment of the generalized-branch-and-bound version of the present invention for Pure Linear Integer Programming Computing System, which is a continuation of FIGS. 8A, 8B, and 8C

FIG. 9A is a flow chart of the a preferred embodiment of the generalized-branch-and-bound version of the present invention for Mixed Linear Integer Programming Computing System, which is continued on FIGS. 9B, 9C, and 9D

FIG. 9B is a flow chart of the a preferred embodiment of the generalized-branch-and-bound version of the present invention for Mixed Linear Integer Programming Computing System, which is a continuation of FIG. 9A, and continued on FIGS. 9C, and 9D

FIG. 9C is a flow chart of the a preferred embodiment of the generalized-branch-and-bound version of the present invention for Mixed Linear Integer Programming Computing System, which is a continuation of FIGS. 9A and 9B, and continued on FIG. 9D

FIG. 9D is a flow chart of the a preferred embodiment of the generalized-branch-and-bound version of the present invention for Mixed Linear Integer Programming Computing System, which is a continuation of FIGS. 9A, 9B, and 9C.

FIG. 10A is a flow chart of the a preferred embodiment of the generalized-branch-and-cut version of the present invention for Mixed Integer Convex Programming Computing System, which is continued on FIGS. 10B, 10C, and 10D

FIG. 10B is a flow chart of the a preferred embodiment of the generalized-branch-and-cut version of the present invention for Mixed Integer Convex Programming Computing System, which is a continuation of FIG. 10A, and continued on FIGS. 10C, and 10D

FIG. 10C is a flow chart of the a preferred embodiment of the generalized-branch-and-cut version of the present invention for Mixed Integer Convex Programming Computing System, which is a continuation of FIGS. 10A and 10B, and continued on FIG. 10D

FIG. 10D is a flow chart of the a preferred embodiment of the generalized-branch-and-cut version of the present invention for Mixed Integer Convex Programming Computing System, which is a continuation of FIGS. 10A, 10B and 10D

FIG. 11 is a functional block diagram illustrating an exemplary computer unit operating environment for an exemplary embodiment of the present invention in a computing environment

### DETAILED DESCRIPTION OF THE PREFERRED EMBODIMENTS

The following detailed description utilizes a number of acronyms and symbols which are generally well known in the art. While definitions are typically provided with the first instance of each acronym, for convenience, Table 1 below provides a list of acronyms and abbreviations used herein along with their respective definitions.

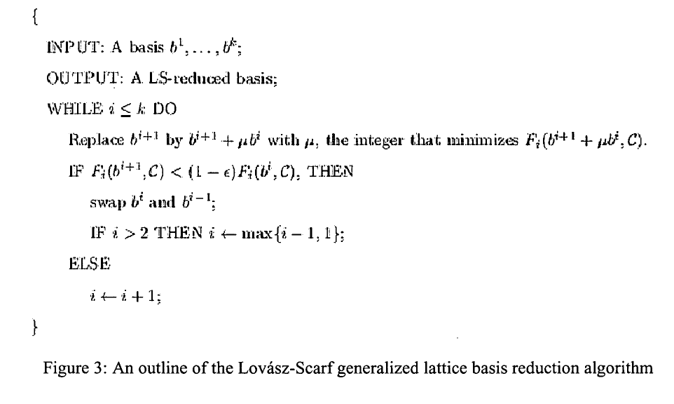

The present invention provides improved methods for the solution of mixed integer programming problems. Specifically, the present invention provides a methodology for computing the branching hyperplane or half-spaces in the original space, without problem reformulation, for a generalized-branch-and-bound algorithm. This methodology is developed using a concept of an integral adjoint lattice basis and a kernel lattice basis or a dual lattice basis. Moreover, the present invention provides techniques for using an integral adjoint lattice basis for computing cutting planes for a more refined generalized branch-and-cut method. Using the kernel lattices, it provides a method for rounding a point to generate an integer feasible solution. It provides a hierarchical approach to computing a reduced basis, or in avoiding its computation to save computational effort. This approach improves on the approach of Wang 1997, by introducing the use of LLL-type basis reduction procedures (FIG. 2) before using generalized basis reduction method (FIG. 3). Finally, the method is combined with the cutting plane scheme to allow solutions of difficult and possibly structured problems. The algorithms disclosed herein provide means for solution of mixed integer linear and convex programming problems. These problems may arise from mathematical models of business, engineering, economic, and biological systems. Applications in the areas of inventory and facility planning, process planning, logistics, water resource management, and financial optimization, etc. are given at the website http://www.gamsworld.org/minlp/minlplib/minlpstat.htm

The concept underlying the present invention are best understood first in the case of generalized branch-and-bound methods for linear pure integer problems, and then to progressively more complex mixed integer linear problems, and mixed integer convex problems. It is then possible to understand further improvements to incorporate cuts to develop a generalized-branch-and-cut algorithm, and finally the use of column generation to develop a generalized-branch-cut-and-price algorithm. The proofs of the theoretical properties of the current invention are given in Mehrotra S., et al. (2004b).

### Definitions of Adjoint, Kernel, and Reduced Lattices

Central to the present invention is the concept of an integral adjoint lattice and reduced integral adjoint and Kernel lattice basis. For an introduction to lattices see (Cassels 1971). The concept of integral adjoint lattice is new to the field of integer programming and U.S.

TABLE 1
Notation

| | |
|---|---|
| BC | Branch and Cut |
| DMA | direct memory access |
| I/O | input/output |
| MILP | Mixed Integer Linear Program |
| MICP | Mixed Integer Convex Program |
| MICPL | Mixed Integer Convex Program with Linear Objective |
| GBR | Generalized Basis Reduction |
| GBB | Generalized Branch and Bound |
| LAN | local area network |
| Lenstra-type | Lenstra Algorithm with infinite or finite precision, |
| | Segment basis reduction algorithm of Koy, et al. (2001) etc. |
| LLL | Lenstra, Lenstra, Lovasz |
| LS | Lovasz and Scarf |
| min | minimize |
| max | maximize |
| ROM | read only memory |
| s.t. | subject to |
| SC | self concordant |
| SCSI | small computer system interface |
| WAN | wide area network |
| x^{T} | transpose of a column vector (i.e., a row vector) |
| ∇f(x) | (gradient) vector of partial derivatives of f with respect to xᵢ |
| ∇² f(x) | (Hessian) matrix of second partial derivatives of f with respect to xᵢ and xⱼ |
| \|\| · \|\|, l₂-norm | any norm of a vector, \sqrt{x^{T}x,} respectively |
| \|\|x\|\|_{Q}, \|\| · \|\|_{Q} | \sqrt{x^{T}Qx,} Q-norm of a vector, respectively |
| Σ | summation of quantities after the argument |
| oracle | a method for computing a required quantity |
| integral vector | a vector is called integral if all its elements are integer |

provisional application Ser. No. 60/614,185 was filed on Sep. 29, 2004 based on this discovery. The use of an integral adjoint lattices allows us to solve and structure the computation of the branching hyperplane/half-space finding problem more effectively. The concept of an integral adjoint lattice together with the concept of kernel and dual lattices, and the concept of reduced lattices are described below.

Given B=[b₁, . . . , bₖ], n>k, L(B):={x∈ [symbol] ⁿ|x=Σᵢ₌₁^{k} [symbol] bᵢ}, is the lattice generated by column vectors bᵢ, i=1, . . . , k. A lattice is called integral if all vectors in L(B) are integer vectors. An integral lattice has an associated unique integral kernel lattice K(B):={u∈ [symbol] ⁿ|u^{T}b=0 for all b∈L(B)}. The lattice K(A^{T}) is represented by Λ. The existence of Λ is well known. The dual of Λ is defined as the set
Λ^{⊥}:={z∈ [symbol] ⁿ|Az=0, z^{T}x∈ [symbol] , for all x∈Λ}.
The set Λ^{⊥} is also a lattice, however, it may not be integral. If Z is a basis for Λ, then Z^{⊥}:=Z(Z^{T}Z)⁻¹ is a basis for Λ^{⊥} and the lattice Λ^{⊥} it is unique.

A lattice K*(A^{T}) is called an adjoint lattice of A if for any basis Z of Λ there exist a basis Z* of K*(A^{T}) such that
Z^{T}Z*=I (3)

A dual lattice satisfy the above definition of adjoint lattices, however, its basis vectors may not be integral. An adjoint lattice is integral if all its elements are integral. Integral adjoint lattices play a fundamental role in the developments of this paper. Henceforth the adjoint lattices are always integral, and we may not use the prefix “integral.”

We may compute an adjoint lattice from the computations of a unimodular matrix U that reduces A to its Hermite Normal Form H (Schrijver, 1986), i.e., AU=[H:0], where H is the Hermite normal form of A. For a matrix A with m rows and n columns, the last (n−m) columns of U give a basis for the kernel lattice Λ, and the last k columns of U^{-T} give the corresponding choice of K*(A^{T}) denoted by Z*. Any matrix in the set L(Z*)⊕L(A^{T}) satisfies (3), and the lattices generated are different. An instance of K*(A^{T}) is represented by Λ*, and a basis of Λ* is represented by Z* satisfying Z^{T}Z*=I for a basis Z of Λ.

Lenstra, Lenstra, and Lovász Reduced Basis of a Lattice

This definition is adapted from (Koy, et al. 2001) for the ellipsoidal norm. Let \hat{B}=[\hat{b}₁, . . . , \hat{b}ₙ] be the orthogonal basis vectors computed by using the Gram-Schmidt orthogonalization procedure as follows:

$${\hat{b}}_{i} = {b}_{i} - {\sum }_{j = 1}^{i - 1} {Γ}_{j , i} {\hat{b}}_{j} , i = 1 , … , n , \qquad ( 4 )$$

where
Γ_{j,i}=bᵢ^{T}E\hat{b}ⱼ/∥\hat{b}ⱼ∥_{E}², and \hat{b}₁=b₁ (5)
Definition 1

A basis b₁, . . ., bₙ of a lattice L is called a LLL-reduced basis, for δ∈(¼, 1), if it has the following two properties:
C1. (Size Reduced) |Γ_{j,i}|≦½ for 1≦j<i≦n
C2. (2-Reduced) ∥\hat{b}ᵢ₊₁∥_{E}²≧(δ−Γ_{i,i+1}²)∥\hat{b}ᵢ∥_{E}², |Γ_{i,i+1}|≦½ for i=1, . . . , n−1

It is assumed that ∥·∥_{E}≠0 for vectors of interest. A basis is called 2-reduced if only C2 is satisfied. It is called size-reduced if only C1 is satisfied. The upper triangular matrix Γ:=[Γ_{j,i}] satisfies Γ^{T}DΓ=B^{T}EB, where D is a diagonal matrix whose elements Dᵢᵢ are ∥\hat{b}ᵢ∥_{E}². Note that Γ can be computed from the Cholesky factors of B^{T}EB. A size-reduced lattice basis is efficiently computable (in polynomial time) from a 2-reduced basis following a recursive procedure.

Lovász and Scarf Reduced Basis

Lovász and Scarf (1992) developed a generalized basis reduction (GBR) algorithm which gives a reduced basis of the lattice [symbol] ⁿ with respect to a generalized distance function F defined on C: F(x,C)=inf{λ|λ≧0x∈λC}. Let C* be the dual of C defined as C:={p|p^{T}x≦1 for all x∈C}. It can be shown that the generalized distance of a point y to the dual set C* is computed by solving an optimization problem defined over C. In particular, F(y,C*)=max_{x∈C}y^{T}x (Lovász, et al. 1992). Let us define

$${F}_{i} ( x , C ) = {min}_{{α}_{1} , … , {α}_{i - 1} ∈ ℝ} F ( x + {α}_{1} {b}_{1} + … + {α}_{i - 1} {b}_{i - 1} , 𝒞 ) . \qquad ( 6 )$$

The function Fᵢ(x,C) is a distance function associated with the projection of C (call it Cᵢ) into the subspace generated by {bᵢ, . . . , bₙ} along {b₁, . . . , bᵢ₋₁}, i.e., x=Σₗ₌ᵢⁿαₗbₗ∈Xᵢ iff there exist αᵢ, i=1, . . . , i−1 such that x+Σₗ₌₁ⁱ⁻¹αₗbₗ∈C. If the constraints defining C are explicitly given, then the functions Fᵢ(x,C) can either be computed directly from (6) or from the solution of
Fᵢ(x,C)=max{x^{T}z|z∈C*, bᵢ^{T}z=0, . . . , bᵢ₋₁^{T}z=0} (7)
Definition 2

A basis b₁, . . . , bₙ is called Lovász-Scarf reduced basis (LS-reduced for short) for a given 0<ε<½ if the following two conditions hold for i=1, . . . , n−1:
(G1) Fᵢ(bᵢ₊₁+μbᵢ,C)≧Fᵢ(bᵢ₊₁,C) for integral μ
(G2) Fᵢ(bᵢ₊₁,C)≧(1−ε)Fᵢ(bᵢ,C)

These conditions reduce to conditions C1 and C2 when C is replaced with an ellipsoid.

Segment Reduced Basis

The concept of a k-segment LLL reduced basis was proposed by (Koy et al. 2001), where an method was also given to compute this basis. An alternative method for computing segment reduced basis, and LLL reduced basis are also given in (Mehrotra et al. 2004). We now give a definition of the segment reduced basis. Let D_{i, . . . , j}:=∥\hat{b}ᵢ∥² . . . ∥\hat{b}ⱼ∥². We denote D_{1, . . . ,} l by dₗ. Note that dₙ is the Gramian determinant of L. When we are considering k segments of B and \hat{B}, D_{k(l-1)+1, . . . , kl}:=∥\hat{b}ₖ₍ₗ₋₁₎₊₁∥² . . . ∥\hat{b}ₖₗ∥² is the segment Gramian determinant, and for simplicity we denote it by D(l), where k is fixed.

Definition 3

A basis b₁, . . . , bₘₖ is called k-segment LLL reduced if the following conditions hold.
(S1) It is size-reduced, i.e., it satisfies [C1] above.
(S2) (δ−Γ_{i,i+1}²)∥\hat{b}ᵢ∥²≦∥\hat{b}ᵢ₊₁∥² for i≠kl, l∈ [symbol] , i.e., vectors within each segment of the basis are δ-reduced, and
(S3) Letting α:=1/(δ−¼), two successive segments of the basis are connected by the following two conditions.
   (C3.1) D(l)≦(α/δ)^{k}^{²}D(l+1) for l=1, . . . , m−1
   (C3.2) δ^{k}^{²}∥\hat{b}ₖₗ∥²≦α∥\hat{b}ₖₗ₊₁∥² for l=1, . . . , m−1

The case where k=O(\sqrt{n}) gives an algorithm for computing a k-segment LLL reduced basis with a significantly reduced worst case computational effort than the computational effort required to compute LLL reduced basis using Lenstra, Lenstra, Lovász method or its variants (see Koy et al. 2001, and Mehrotra et al. 2004). Henceforth, we will refer to a k-segment LLL reduced basis by segment reduced basis. It is shown in (Koy et al. 2001, Lenstra, et al. 1982, and Lovász, et al. 1992) that the first vector of a segment-reduced, LLL-reduced, and LS-reduced basis gives an approximation to the shortest vector (where length is measured using the ellipsoidal or generalized norm) in the lattice for which good theoretical bounds can be proved. Hence, it is a short (not necessarily shortest) lattice vector. Also, one expects these basis vectors to be approximately sorted by increasing length.

The concepts of the segment reduced basis, LLL reduced basis, and LS reduced basis are used subsequently in generating the branching hyperplanes and half-spaces. Because of the increasingly more computational efforts the present invention uses the segment reduced, the LLL reduced and the LS reduced basis in a hierarchy when computing a reduced basis of a lattice. The parameters α, δ, and ε used in the definition of these basis are control parameters whose different values are experimented with, before making a default selection for the system, or these values are provided by the user of the system.

Range and Null Space of a Matrix

The range space of a m×n matrix A, {x∈ [symbol] ⁿ|x=Σᵢ₌₁^{m} [symbol] A^{T}eᵢ}, is represented by [symbol] (A). The null space of A is given by N(A):={p∈ [symbol] ⁿ|Ap=0}.

### Definitions of a Generalized-Branch-and-Cut Tree

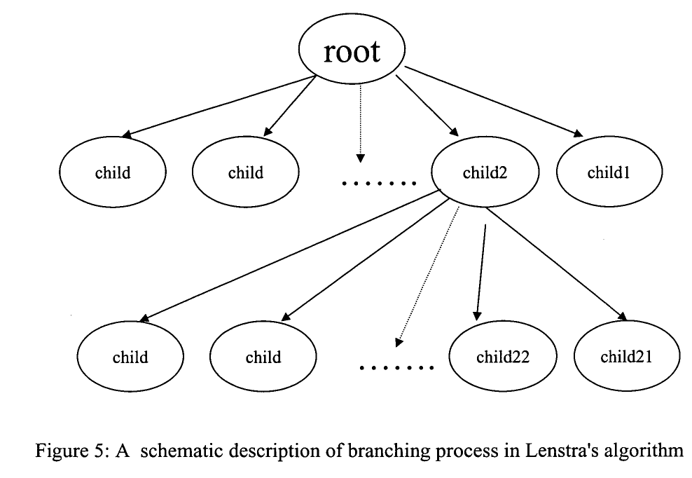

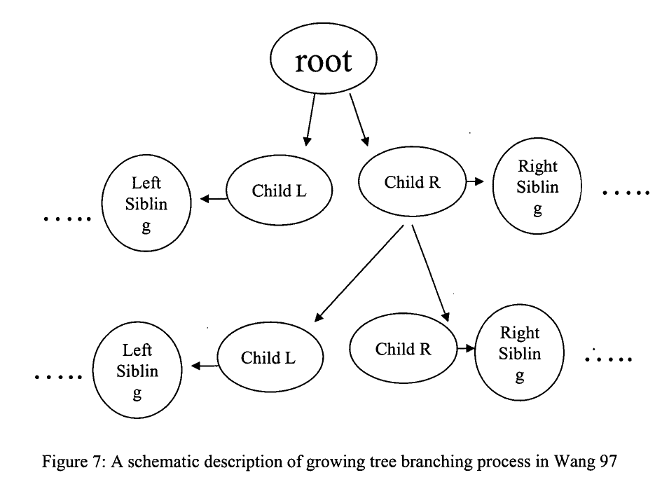

Schematic examples of a generalized branch-and-bound tree is shown in FIGS. 5 and 7. A generalized-branch-and-cut tree consists of root and children nodes which consists of levels. Root node is at level 0. The children nodes and siblings are generated using a tree generation logic. Nodes at level k generate children nodes at level k+1, or children nodes may generate their siblings at the same level. Each node at level k generates its own children at level k+1. The node at level k+1 generating siblings generates siblings for its own family connected through the parent node at level k. The root and children nodes comprise of a mixed integer program. The children nodes inherit objectives and constraints from their parent (node at level k generating its children at level k+1). One branching hyperplane or half-space is added to the constraints at the parent node to generate a child node. In contrast to the branch-and-bound tree where the added constraint uses singe variable, in the generalized-branch-and-bound tree this added constraint takes the form of a general linear expression using multiple variables in the form of a general hyperplane or half-space. A parent node may generate multiple children all of which are generated by adding a hyperplane differing only in one right hand side parameter. This is the family of children generated by a parent node. Sibling nodes in a family of children are also connected through the same right hand side parameter.

In a generalized-branch-and-cut tree, while inheriting constraints from the parent node new constraints (cuts) are added to tighten the continuous relaxation of the problem without deleting any mixed integer solutions that may be feasible for this node. These cuts may be added at the root node or at any other node of the tree.

### Mixed Integer Convex Program, Convex Functions and Self Concordance Definitions and Preliminaries

The problem is called a mixed integer linear program (MILP) when the functions cᵢ(x) are linear functions. A function c(x) is called a convex function over a set C if c(λ¹x¹+λ²x²)≦λ¹c(x¹+λ²c(x²) for λ¹+λ²=1,λ¹,λ²≧0, and all x¹,x² C. A set is called convex if the line joining any two points in the set belong to the set. The continuous relaxation (defined below) of the feasible set of PILP, MILP, and MICP are convex sets. A function is called strictly convex if the above inequality is strict. To distinguish a general nonlinear function from a convex function we denote a convex function by cᵢ(x).

The mixed integer convex problem (MICP) finds an integer optimal solution to the problem:
minimize c₀(x)s.t. cᵢ(x)≦0 for i=1, . . . , l, Rx=r, xᵢ∈, i=1, . . . n (8)

where c, x∈ [symbol] ^{m+\overline{n}} are vectors of n+\overline{n} dimension, R∈ [symbol] ^{(m+\overline{m})×(n+\overline{n})} is an integer (or rational) matrix of m+\overline{m} rows and n+\overline{n} columns, r∈ [symbol] ^{m+\overline{m}}, is a m+\overline{m} dimensional integral (or rational) vector and cᵢ(x): [symbol] ^{n+\overline{n}}→ [symbol] for i=1, . . . , l (evaluating a n+\overline{n} vector to a real number) are convex functions. The number of variables, n+\overline{n}, in the problem can be greater than the number of integer variables n. The coefficients of vector c, and matrix R are known. The structure of gᵢ(·) is either known so that the mathematical function, its first and possibly second partial derivatives may be evaluated—or—the function and its partial derivatives may be computed through an external function call to another procedure. In case of convex functions (defined below) it is sufficient that we can compute a subgradient of this function. The concept of subgradients generalizes the concept of gradient (see Bazaraa et al. 1993) for non-differentiable convex function.

A continuous relaxation of the set of feasible solutions in MICP is represented by C, i.e.,
C≡{x|cᵢ(x)≦0, i=1, . . . , \hat{m}, Rx=r}.

A problem is a continuous relaxation of the mixed integer programming problem when the objective function is optimized over the convex set C.

While convex functions include many different examples, convex function that satisfy a self-concordance condition provide useful theoretical properties. Let ƒ: [symbol] ⁿ→ [symbol] be a twice differentiable strictly convex function defined over the set
Ĉ:={x|cᵢ(x)≦0, i=1, . . . , l},

where cᵢ(·) are convex functions as defined before. Let Ĉ⁰ be the interior of Ĉ. Following Renegar (Renegar, 2001) (see also Nesterov and Nemirovskii, 1994) the function ƒ is called self-concordant (SC) if for all x∈Ĉ and y∈{y|∥y−x∥_{∇}_{²}_{ƒ(x)}≦1}, we have

$$1 - ‖ y - x ‖ {∇}^{2} f ( x ) \leq \frac{‖ υ ‖ {∇}^{2} f ( y )}{‖ υ ‖ {∇}^{2} f ( x )} \leq \frac{1}{1 - ‖ y - x ‖ {∇}^{2} f ( x )} ,$$

for all v≠0. Here ∇²ƒ(x) is the matrix of second partial derivatives (Hessian matrix) of ƒ, and ∥t∥_{Q} is equal to \sqrt{t^{T}Qt}, which is the ellipsoidal norm of t measured using a positive definite matrix Q. A self-concordant barrier associated with Ĉ is a SC function with the additional property

$$θ := {sup}_{x ∈ {\hat{𝒞}}^{0}} {‖ ∇ f ( x ) ‖}_{{∇}^{2} f ( x )} < ∞ .$$

Here sup is the largest possible value the function in the argument can take. The parameter θ is called the complexity value of ƒ. A restriction of a SC barrier with complexity value θ on a subspace (or its translation) (see Renegar 2001, page 35) is also a SC barrier with complexity value θ. Hence, without loss of generality, we will refer to ƒ as a barrier function over C. The minimizer of a barrier function is called an analytic center associated with the barrier. The SC barrier functions are known for many important examples of ‘cᵢ(x)≦0’, such as a semi-definite and second order constraints. When the functions cᵢ(x) are linear the most popular barrier function is the log-barrier. The log-barrier analytic center for MILP is given by the solution of

$$max \text{\{} ρ ( x , 𝒫 ) := - {\sum }_{i = 1}^{n} ln ( - {c}_{i} ( x ) ) \vert Rx = r \} .$$

Henceforth, we will represent a SC barrier function for a constraint ‘cᵢ(x)≦0’ by ln(−cᵢ(x)). The ln could be either a direct log of the function −cᵢ(x) or some transformation of this function.

For (MICP) with admitting a solution x satisfying x∈{x|Rx=r, cᵢ(x)<0, i=1, . . . , l} (has a relative interior) the analytic center is a solution of

$$max \text{\{} ρ ( x , 𝒞 ) := - {\sum }_{i = 1}^{l} ln ( - {c}_{i} ( x ) ) \vert Rx = r \} .$$

The log-barrier analytic center is well defined if the inequality constraints are given by convex functions and the feasible set is bounded. The assumptions of non-empty relative interior and boundedness of the set are satisfied using the standard techniques of using artificial variables, and a large upper bound on the magnitude (e.g., l₂-norm) of the solution. The gradient and Hessian of the log-barrier at a point x are given by:

$$∇ ρ ( x , 𝒫 ) = - ( 1 / {x}_{i} ) , {∇}^{2} ρ ( x , 𝒫 ) = [ diag ( 1 / {x}_{i}^{2} ) ] , \\ \begin{matrix}∇ ρ ( x , 𝒞 ) = - {\sum }_{i = 1}^{l} \frac{1}{{c}_{i} ( x )} ∇ {c}_{i} ( x ) , {∇}^{2} ρ ( x , 𝒫 ) \\ = {\sum }_{i = 1}^{l} [ \frac{1}{{c}_{i}^{2}} ∇ {c}_{i} ( x ) ∇ {{c}_{i} ( x )}^{T} + \frac{1}{{c}_{i} ( x )} {∇}^{2} {c}_{i} ( x ) ] .\end{matrix}$$

Availability of an Ellipsoidal Approximations of a Convex Set

For a SC barrier function ƒ(x) associated with Ĉ with complexity value θ, and the corresponding analytic center we have (see Renegar 2001, Corollary 2.3.5) the property that

$$ɛ ( w , {∇}^{2} f ( w ) ) ⊆ 𝒞 ⊆ ɛ ( w , \frac{1}{4 θ + 1} {∇}^{2} f ( w ) ) . \qquad ( 9 )$$

This means that the analytic center and the Hessian of an SC barrier function together provide a provably good ellipsoidal approximation of set defined by SC convex functions.

In fact, we don't need exact computations of w. It is sufficient to find an approximate w. Let \tilde{w}∈C be such that ∥p∥_{∇}_{²}_{ƒ(x)}≦¼, where
p:=−∇²ƒ(\tilde{w})⁻¹ƒ(\tilde{w})

is the Newton direction of ƒ at \tilde{w}. From (Renegar 2001, Theorem 2.2.5) we also have ∥w−\tilde{w}∥_{∇}_{²}_{ƒ(\tilde{w})}≦½. Now using the definition of self-concordance function we can see that

$$ɛ ( \tilde{w} , 2 {∇}^{2} f ( \tilde{w} ) ) ⊆ 𝒞 ⊆ ɛ ( \tilde{w} , \frac{1}{4 ( 2 θ + 1 )} {∇}^{2} f ( \tilde{w} ) ) .$$

The log-barrier function ρ(x):=−Σᵢ₌₁^{l}ln(−cᵢ(x)) is a self concordant barrier in many important situations. In particular, for the n dimensional non-negative orthant, the second-order cone

$${‖ [ \begin{matrix}{x}_{2} \\ ⋮ \\ {x}_{n}\end{matrix} ] ‖}_{2}^{2} \leq {x}_{1}^{2}$$

defined using n variables, and semidefinite cones over n×n semidefinite matrices (using determinants), this barrier has complexity values n, 2, and n respectively.

If the functions cᵢ(x) are non-differentiable convex functions, it is still possible to compute a good central point and an ellipsoidal approximation of the set C using Vaidya's volumetric center method as described in (Vaidya, 1996) and (Anstreicher, 1999) and modified for the presence of equality constraints in the problem. For this method it is sufficient to have a procedure (oracle) providing an inequality that separates an infeasible point from the convex set. Hence, we can say that the existing art shows that an ellipsoidal approximation of a convex set with equality constraints is computable.

### Present Invention for Pure Integer Linear Programming Problems

The pure integer programming problem is to find a solution that
minimize the objective: c^{T}x
satisfying constraints: Ax=a,
   xᵢ≧0 and it is integer for all i=1, . . . , n

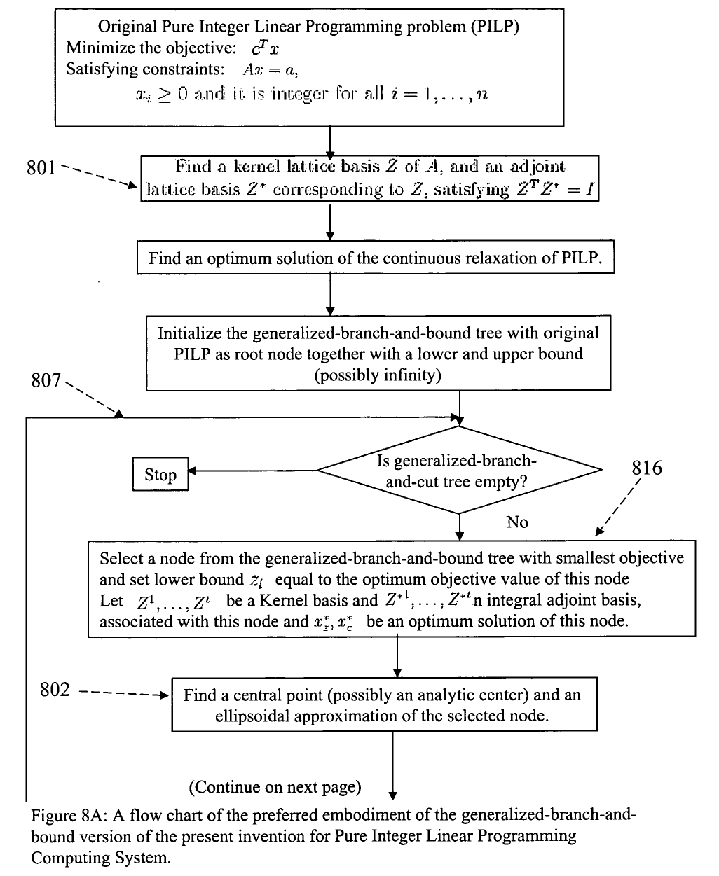

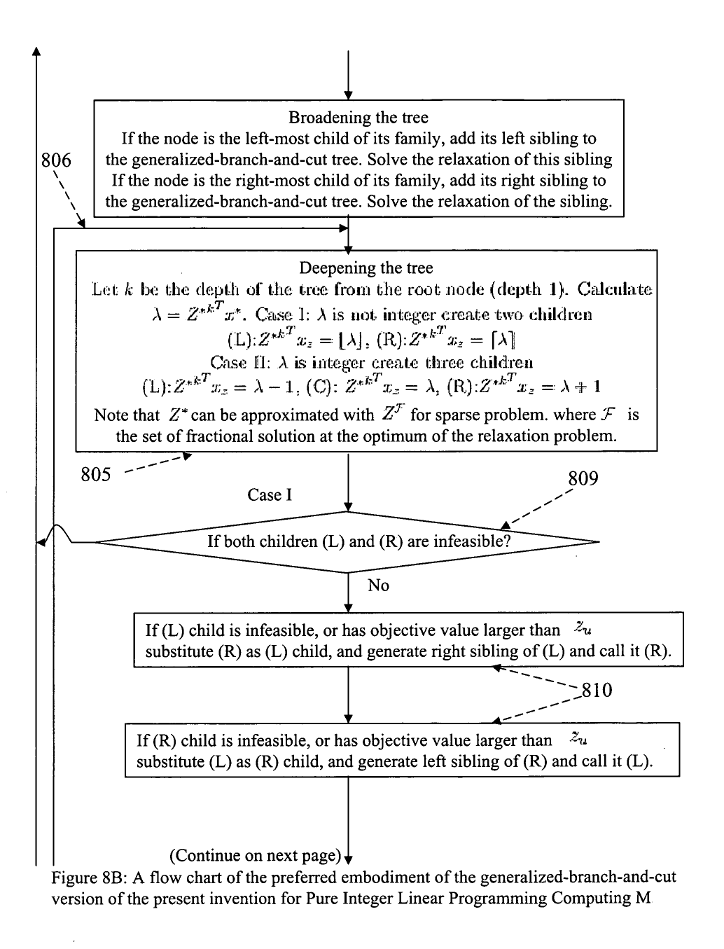

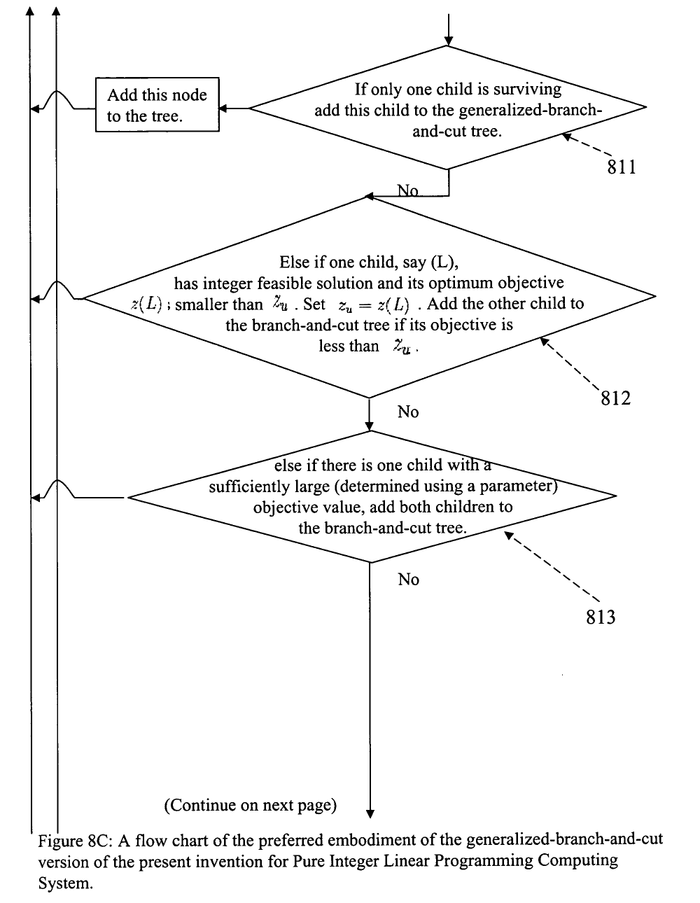

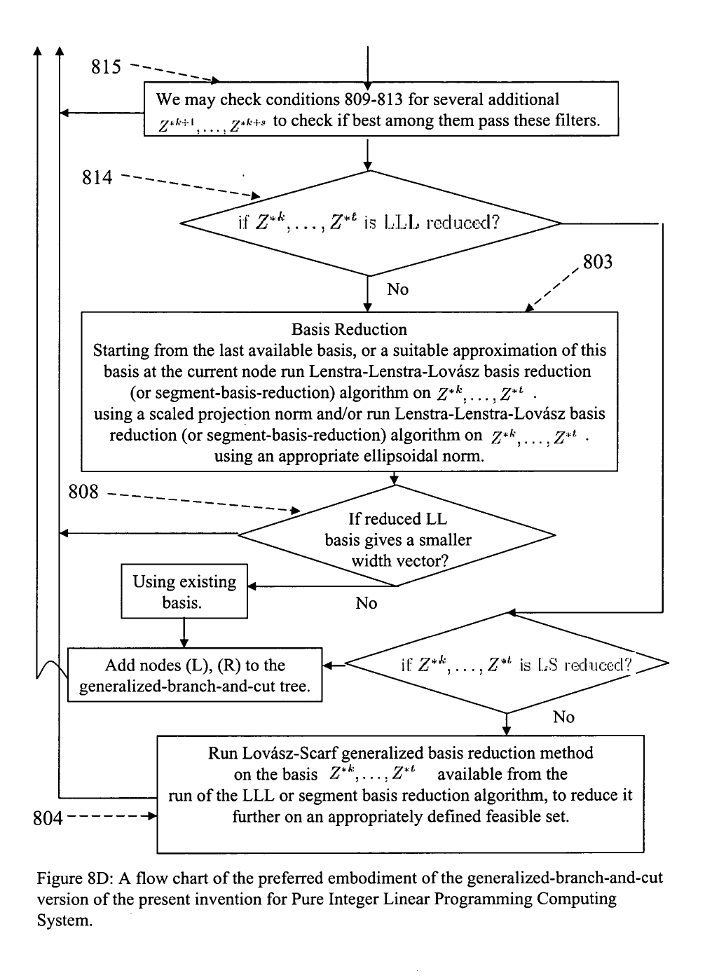

Without loss of generality we will use P:={x|Ax=a, x≧0} to represent a node in the branch and bound process of PILP. FIG. 8 gives a flow diagram of the generalized-branch-and-bound method of a preferred embodiment of the present invention. As hyperlanes and half-spaces the matrix A increases in the number of rows it has, however, half-spaces are converted to hyperplanes as a node is chosen for the solution of its continuous relaxation in step labelled 815 in FIG. 8.

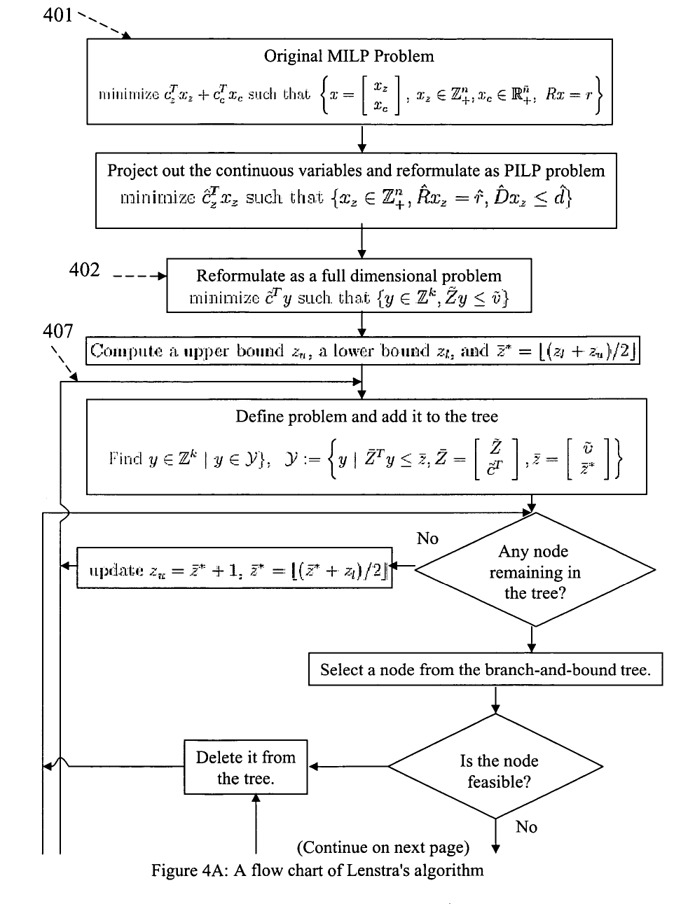

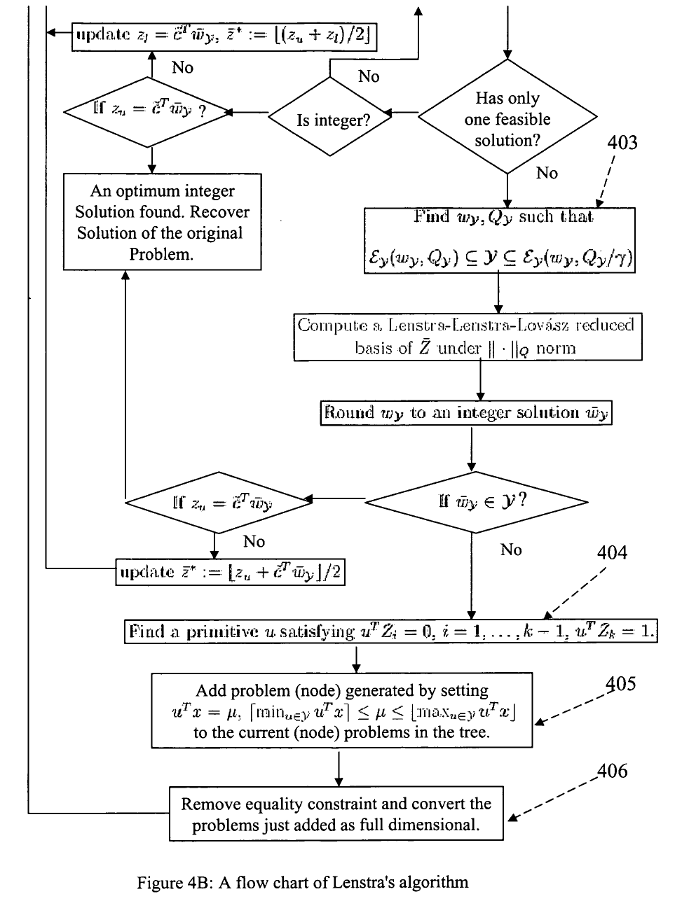

The steps labelled 801-804 provide improvements over the previous art for pure integer linear programming based on Lenstra branching on hyperplane method. The computation of kernel and integral adjoint lattice (label 801) is a core step introduced based on the invention of integral adjoint lattices. Furthermore integral adjoint lattices (or dual lattices) play a central role in allowing us to directly compute a branching hyperplane or half-space (used in step 805—deepening the tree) for which it is possible to establish good theoretical properties. Loops 806 and 807 also provide improvement of the previous art by providing a richer hierarchical structure before using the generalized basis reduction algorithm (label 804). Step of problem generating a full dimensional problem (Label 401 FIG. 4) is Lenstra's original algorithm is no longer performed. No bisection method is needed as used in loop 407. In Lenstra's algorithm the generalized-branch-and-bound tree is generated by adding all the hyperplanes at the same time (Label 405). In the present invention the branching process follows a growing tree scheme as was also used by Wang (Wang 1997). Note that in this scheme only two half spaces (and a hyperplane in Case II of Label 805) are added. A schematic comparison of the branching in Lenstra's algorithm and growing tree branching is given in FIGS. 5 and 7. In Lenstra's algorithm remove the added equality constraints (Label 406) by a process of dimension reduction. The present invention has no such requirement. The method for generating the branching hyperplanes is also different (Label 404), since it formulates the problem of finding a branching hyperplane/half-space in the original space and works through a hierarchy of approximations of this problem. This is explained further below.

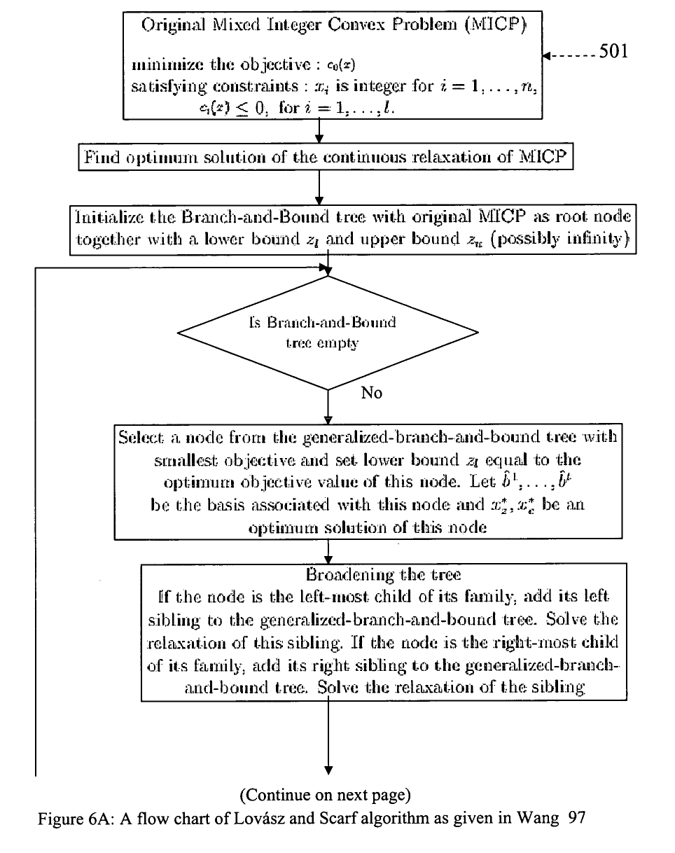

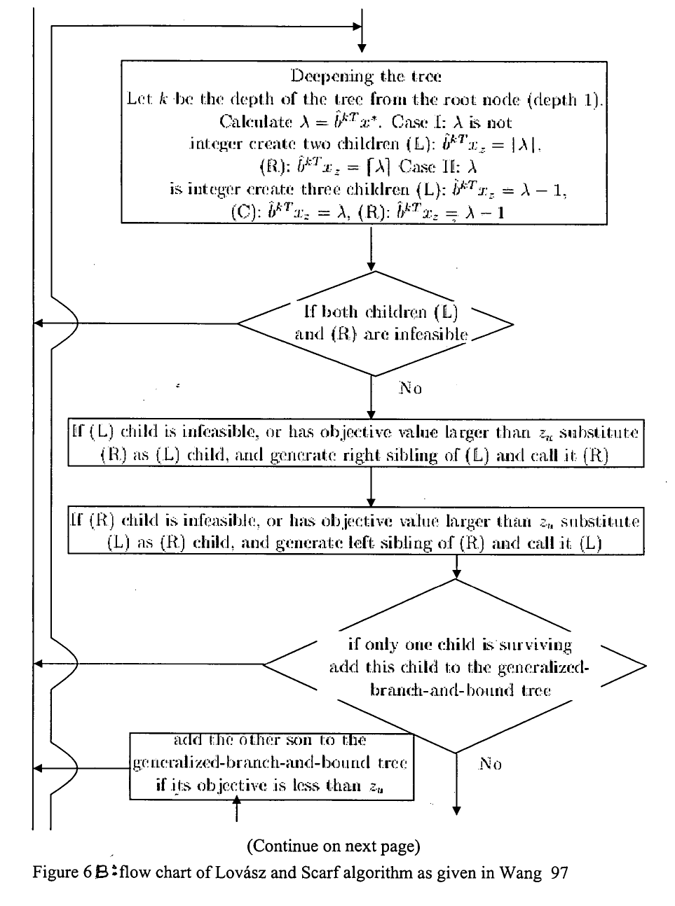

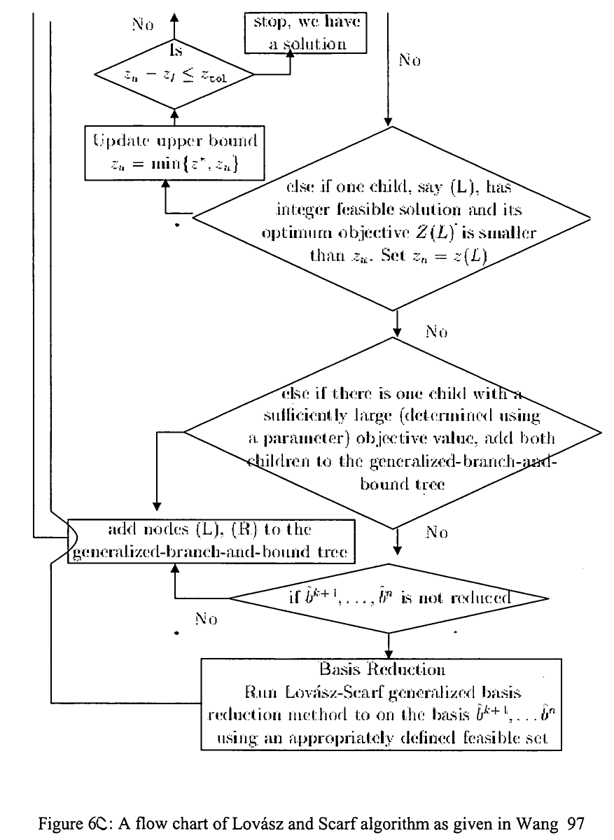

A flow chart of the algorithm in Wang (Wang 1997) is given in FIG. 6. The present invention is an improvement over Wang (Wang 1997) in the following way. Wang assumes that the problem has no equality constraints (label 501). In order to achieve this we will need to perform a dimension reduction step like (label 402) in FIG. 4 for Lenstra's algorithm. The case where equality constraints are present in the original problem, which is typically how optimization models are formulated, is not discussed in Wang's work. After all the logical check for avoiding to run a basis reduction algorithm Wang enters in to a generalized basis reduction step. In the present invention this is replaced by a hierarchy of computations (815, 803) as discussed below. This hierarchy involves the use of an approximation of the current integral adjoint lattice basis, use of an exact integral adjoint lattice basis, use of segment lattice basis reduction algorithm, use of LLL basis reduction algorithm, and finally the use of generalized basis reduction algorithm. This hierarchy may extend to finding the exact shortest lattice basis, and other types of reduced basis. In fact, a vector from the GBR basis is used only if it gives an improvement over the ALL basis. Also, an LLL reduced basis is used only if it gives an improvement over the current basis. In A version of the preferred embodiment of the present invention the LLL basis reduction is performed only once immediately after the integral adjoint or the Kernel lattice basis is computed in label 801. Furthermore, Wang does not consider rounding of a solution to an integer solution (802).

We can show that either it is possible to find a feasible integer solution of PILP or it is possible to find a vector in an integral adjoint lattice along which the integer width of the feasible set is bounded in a polynomial that is fixed in n. The integer width of a convex set C along an integral vector u is defined to be

$$𝒲 ( u , 𝒞 ) := {max}_{x ∈ 𝒞} {u}^{T} x - {min}_{x ∈ 𝒞} {u}^{T} x .$$

We can show that the vector along which the width W(u,P) is minimized is always contained in an integral adjoint lattice. Hence, once an integral adjoint lattice is computed the problem of finding the minimum width vector is

$${min}_{u ∈ Λ * \backslash 0} 𝒲 ( u , 𝒫 ) \qquad ( 10 )$$

The present invention solves the problem (10) approximately using a hierarchy of computations that increase in complexity. A more computationally intensive procedure is called when the less computationally intensive procedure fails to produce a good branching hyperplane/half-space based on the pre-specified criterion. This is possible because of the explicit formulation of (10) using an integral adjoint or kernel or dual lattice, and the use of approximation of P in the space of original variables without dimension reduction, as explained above when comparing the present invention with previous art of Lenstra's algorithm (Lenstra 1982, Gao, et al. 2002) and Lovász-Schriver's algorithm (Wang 1997).

The process starts with first trying the existing basis and checking the quality of children it produces. If it produces no feasible child (node), we go back to selecting a new node (label 809). If it produces a left child which gives a child with a objective value higher than the upper bound, then we know that this child and its left siblings are infeasible. We delete this node, and relabel its right sibling as left child, and then take the right sibling of this node (label 810). A similar logic is used if the right child is infeasible or produces an objective value for its relaxation problem that is larger than the upper bound (label 810). Next if we find that only one child is surviving (label 811) we add this child to the generalized branch-and-bound tree and return to picking the next node from the generalized-branch-and-bound tree without performing a basis reduction. Similarly, if one of the child has produced a feasible integer solution we add the other child to the tree and return to picking the next node from the generalized-branch-and-bound tree (label 812). Next if both child are feasible but have a significantly large objective value (but smaller than the upper bound), we add the two children to the generalized-branch-and-bound tree. It is only after a sequence of filters we run a basis reduction algorithm (label 813). Filters 809-813 were also used in Wang (Wang 1997). However, because of the present invention and our ability to find reduce basis which provide hyperplanes in the original space, we now introduce the next filter (label 814) of using the LLL basis reduction algorithm (label 803) of FIG. 8, or its original version with finite precision, or segment basis reduction algorithm of (Koy, et al. 2001) and (Mehrotra, et al. 2004). Here for simplicity we have only shown the use of LLL basis reduction algorithm. Only after the LLL-basis reduction fails to produce a branching hyperplane/half-space with desirable properties, we introduce the use of GBR algorithm (label 804). Furthermore, we check if this procedure produces a better basis than the basis computed using LLL-basis reduction algorithm. In summary, the present invention replaces one basis reduction step with a hierarchy of possible basis reductions, to efficiently identify a branching hyperplane. Furthermore, it does not perform a basis reduction step if it is not expected to yield better performance. Also, before starting the basis reduction procedure one will also check if the filters 809-813 are satisfied of an additional few existing basis vectors. Since the number of such checks (one or more) may vary and may be determined while running the algorithm this process is indicated by a dashed loop (label 815) in FIG. 8. In order to achieve further efficiency a further modification to approximate the integral adjoint lattice Z*^{k} with a suitable lattice, such as the [symbol] ^{F} lattice (label 805) is also allowed. Here F gives the set of indices of variables that are fractional at the optimum solution of the relaxation problem at the current node, and [symbol] ^{F} represent the set of columns of an identity matrix whose index is in the set F. Such a modification is important when the problem is very large and the data in the constraint matrix A is sparse. In one embodiment of the present invention the LLL basis reduction is performed only once under a suitable approximation of the ellipsoidal norm as explained below, and this basis is used throughout the generation of generation of the generalized-branch-and-bound tree.

Let ε(w,Q):={x|(x−w)^{T}Q(x−w)≦1, Ax=a} be computed using an analytic or log-barrier center of P. w is taken to be the center, and Q is taking to be the Hessian matrix of the barrier function. The branching hyperplane finding problem for the ellipsoid ∈(w,Q) is to solve the minimization problem:

$${min}_{u ∈ Λ * \backslash 0} 𝒲 ( u , ɛ ( w , 𝒬 ) ) , or equivalenty , {min}_{u ∈ Λ * \backslash 0} 𝒲 ( u , ɛ ( 0 , 𝒬 ) ) , \qquad ( 11 )$$

where ε((0,Q)={x∈ [symbol] ⁿ|∥x∥_{Q}≦1, Ax=0}. For any u∈ [symbol] ⁿ, min_{x∈ε(0,Q)}u^{T}x=−max_{x∈ε(0,Q)}u^{T}x, the width of the ellipsoid ε(0,Q) along u∈ [symbol] ⁿ is
W(u,ε(0,Q))=2∥Q^{-1/2}u∥p_{AQ}_{^{−1/2}} (12)
where P_{AQ}_{^{−1/2}}=I−Q^{-1/2}A^{T}(AQ⁻¹A^{T})⁻¹AQ^{-1/2}, or P_{AQ}_{^{−1/2}}=Q^{1/2}Z(Z^{T}QZ)⁻¹Z^{T}Q^{1/2} is an orthogonal projection matrix. In particular, the following these formulations to identify a good u∈Λ*, that gives a branching hyperplane in the original space with desirable theoretical properties.

$$\begin{matrix}\frac{1}{2} {min}_{u ∈ {Λ}^{*} \backslash 0} 𝒲 ( u , ɛ ( 0 , Q ) ) = {min}_{p ∈ {Z}^{k} \backslash 0} {‖ {Q}^{- 1 / 2} {Z}^{*} p ‖}_{{P}_{{AQ}^{- 1 / 2}}} & ( 13 ) \\ = {min}_{p ∈ {Z}^{k} \backslash 0} \sqrt{{{p}^{T} ( {Z}^{T} QZ )}^{- 1} p} & ( 14 ) \\ = {min}_{p ∈ {Z}^{k} \backslash 0} ‖ {Q}^{1 / 2} {Z ( {Z}^{T} QZ )}^{- 1} p ‖ . & ( 15 )\end{matrix}$$

An approximation of any one of these problem formulations is generated using the LLL algorithm using an appropriate ellipsoidal norm. For example, we may generate a LLL reduced lattice basis of Q^{-1/2}Z* by running the LLL algorithm using the norm P_{AQ}_{^{−1/2}}-norm, or we may generate a LLL reduced lattice basis of an identity lattice under the (Z^{T}QZ)⁻¹-norm. This approximation is provably good, i.e., if we are unable to generate a feasible integer solution (and thereby improve the upper bound on the optimum objective value), then we must be able to find a branching hyperplane/half-space along which the continuous relaxation of the convex body is bounded by a number that is fixed once the dimension of the problems is fixed. We can further approximate the lattice basis reduction computations if we desire only weaker theoretical properties. For example, in an embodiment of the present invention LLL basis reduction algorithm may be substituted with segment basis reduction algorithm, and furthermore, Q may be approximated with I in equations (13-15). Other such approximation of the ellipsoidal representations, such as computation of inexact centers and matrices at those point, are seen as variation of the hierarchical approach of the present invention. Also, we may approximate Z*^{k} with Z^{F}. Here F gives the set of indices of variables that are fractional at the optimum solution of the relaxation problem at the current node, and [symbol] ^{F} represent the set of columns of an identity matrix whose index is in F. Furthermore, the set F may be expanded to incorporate variables that are good candidates to have a nonzero in a good branching hyperplane/half-space. Hence, the overall hierarchy of computations for the branching hyperplane/half-space span from the use of existing (possibly reduced) integral adjoint lattice basis (or kernel lattice), to using an approximation of an integral adjoint lattice basis and reducing it, to using an exact integral adjoint lattice basis (or kernel or dual lattice) and reducing it using a variety of different methods.

We can round the central point in (label 802) using the following procedure that is part of the present invention. The center of the ellipsoid w is rounded to an integral feasible solution as follows. Let v be any integral solution satisfying Av=a. Now consider the closest lattice vector (CLV) problem:

$${min}_{q ∈ Λ \backslash 0} ‖ w - v - q ‖ 𝒬 \qquad ( 16 )$$

If the solution of (16) is feasible, we are done; otherwise, (as shown below) we must have a u∈Λ* along which the ellipsoid ε(w,Q) (and by extension the set P or C) is thin. Let Z₁, . . . , Zₖ be a LLL-reduced basis of Λ under the ellipsoidal norm ∥·∥_{Q}, i.e., Q^{1/2}Z is LLL-reduced under l₂-norm. Since w−v∈N(A) and Z is a basis for N(A), we have ζᵢ∈ [symbol] , i=1, . . . , k, such that w−v=Σᵢ₌₁^{k}ζᵢZᵢ. Now generate a vector \tilde{v}=Σᵢ₌₁^{k}└ζᵢ┐Zᵢ, and take \overline{v}=v+\tilde{v} as a candidate solution. Here └ζᵢ┐ represents an integer that is nearest to ζᵢ. Clearly, A\overline{v}=a. If \overline{v}≧0, then we have a feasible solution; Otherwise, (w−\overline{v})^{T}Q(w−\overline{v})>1. In the latter case we can know that a branching hyperplane/half-spaces exists along which the width of P is bounded by a constant, whose value is only a function of n. Approximate choices of \tilde{Q} and w are also considered as part of the present invention. In particular, we may use different approximate choices of w, and possibly replace \tilde{Q} with an identity matrix.

### Present Invention for Mixed Integer Linear Programming Problems (MILP)

The mixed integer linear programming problem has the following form:
minimize the objective: c^{T}x
satisfying constraints: Rx=r,
   xᵢ≧0 is integer for i=1, . . . , n, xᵢ≧0 is real for i=n+1, . . . n+\overline{n}

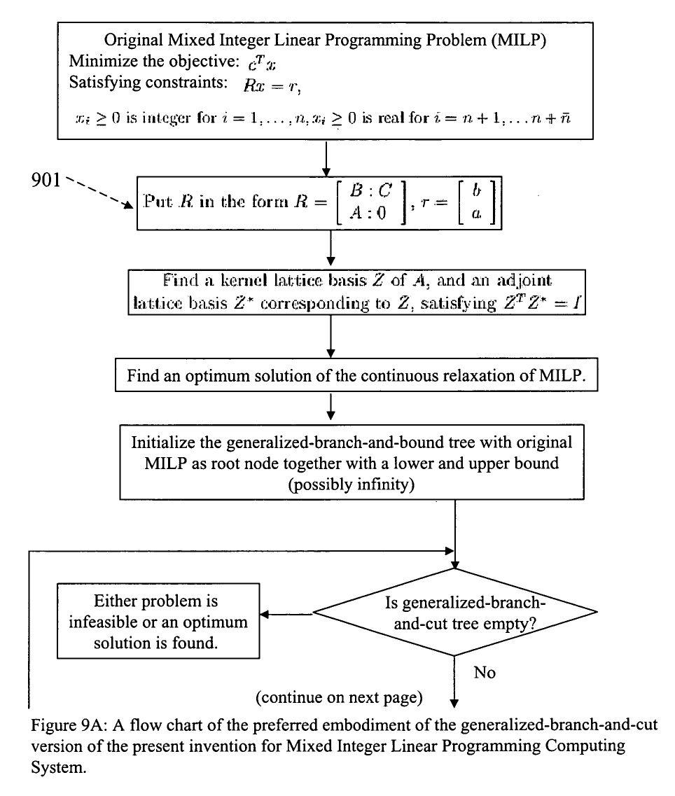

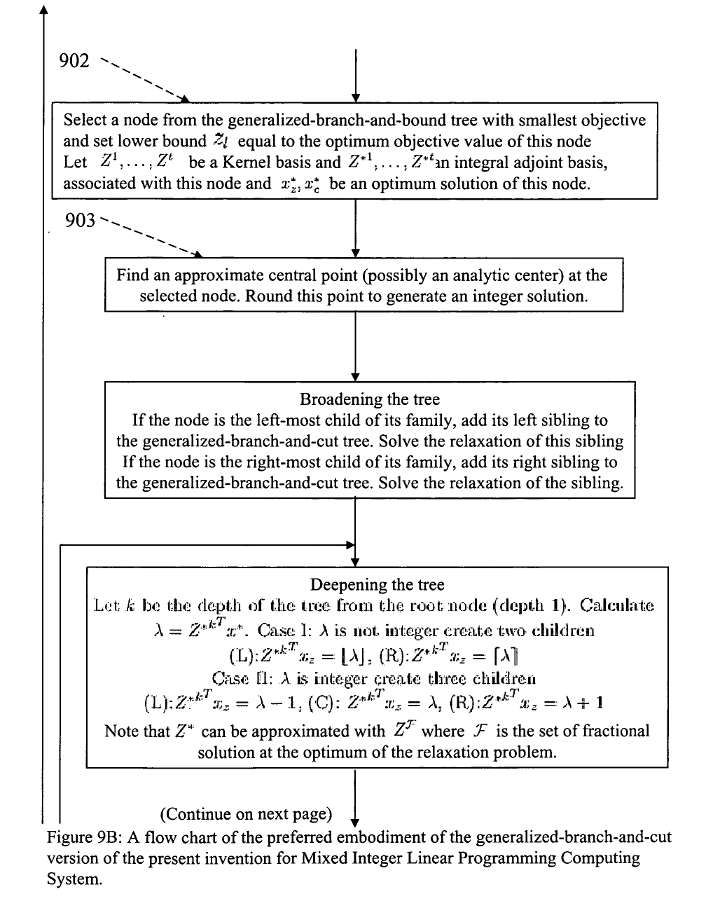

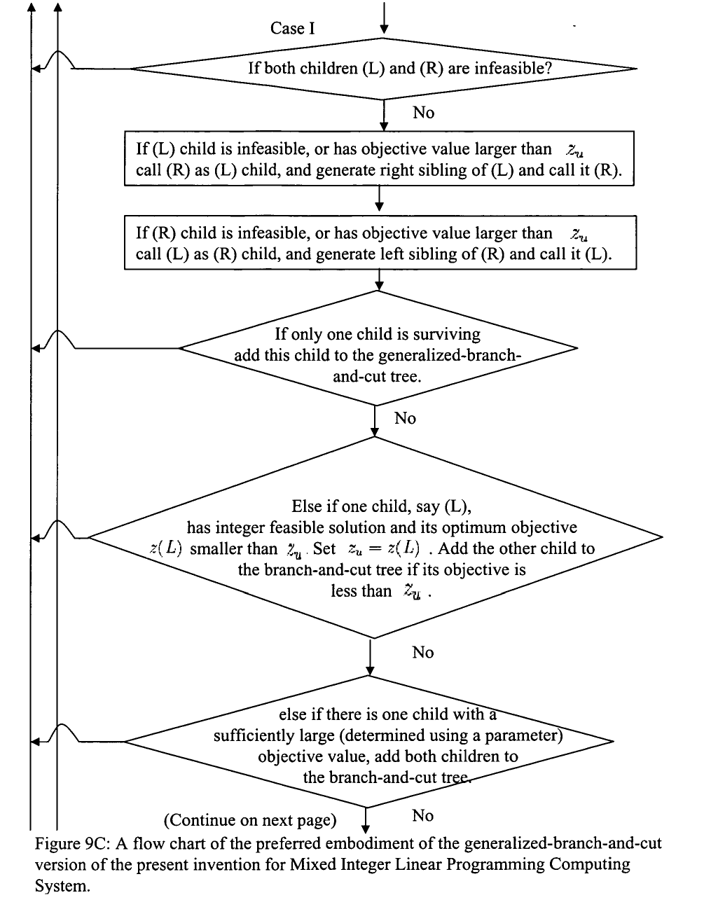

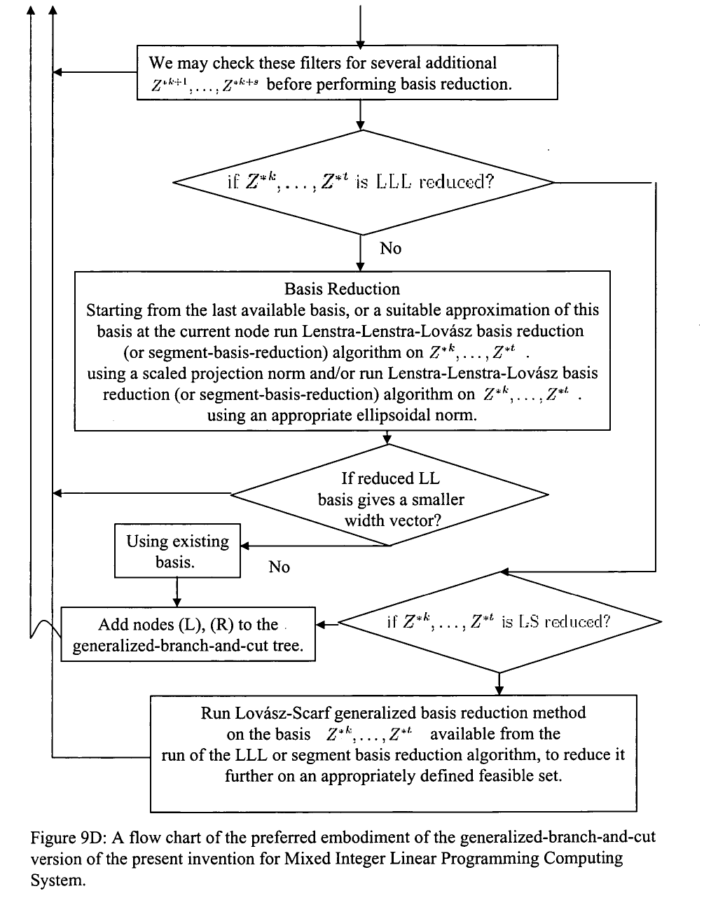

We will use \overline{P}:={x|Rx=r, x≧0} to represent a node in the branch and bound process of MILP. Note that as hyperlanes and half-spaces are added the matrix R increases in the number of rows it has. Half-spaces are converted to hyperplanes as a node is chose for the solution of its continuous relaxation in step labelled 902 in FIG. 9.

All the improvements of the new art for PILP over the existing art are carried over to the new art for MILP. We now discuss the improvements that are unique to MILP because of its more general structure (allowing continuous variables).

In the new art for MILP the step Lenstra's algorithm of eliminating the continuous variables through a projection process is replaces with a step of performing one time computation of identifying a matrix A from R by putting R a form has the form

$$R = [ \begin{matrix}B & ⋮ & C \\ A & ⋮ & 0\end{matrix} ] ,$$

$$r = [ \begin{matrix}b \\ a\end{matrix} ] ,$$

B∈ [symbol] ^{\overline{m}×n}, and C∈ [symbol] ^{\tilde{m}×\overline{n}}. The columns of A correspond to the integer variables, and the columns of C correspond to the real variables. 0 indicates a matrix of all zeros. C has a full row rank. If this is not the case, then we have a π such that π^{T}C=0, allowing us to delete a constraint for which πᵢ≠0, and replace it with the constraint π^{T}B=π^{T}b. A is computed once in order to compute its kernel Z and an integral adjoint lattice basis Z* as in the case of PILP. Subsequently all computations are performed with the original R (where linearly dependent rows of R are deleted, if they don't declare infeasibility).

In the new art a central point and an ellipsoidal approximation (label 903) is computed in the original space. All basis reduction computations using LLL-type algorithms are performed using information from this approximation.

We can show that either it is possible to find a feasible integer solution of MILP or it is possible to find a vector in an integral adjoint lattice along which the integer width of the feasible set is bounded in a polynomial that is fixed in n+ñ. First they show that the vector along which the width W(u, \overline{P}) is minimized is always contained in an integral adjoint lattice Λ* generated by basis Z* appended by zeros for the continuous variables. In particular, they show that there exists a u* in the lattice generated by Z* such that

$${max}_{x ∈ \overline{𝒫}} {u}^{* T} {x}_{z} - {min}_{x ∈ \overline{𝒫}} {u}^{* T} {x}_{z} = 𝒲 ( u , {Proj}_{{x}_{z}} ( \overline{𝒫} ) ) ,$$

where x_{z} represents the vector of integer variables. If \overline{P} is approximated with an ellipsoid ε(w,Q) such that ε(w,Q)={xε [symbol] ^{n+\overline{n}}|∥x−w∥_{Q}≦1, Rx=r} inscribed in \overline{P} and ε(w,Q)⊂\overline{P}⊂∈(w,Q/γ), where γ is the approximation parameter, then the branching hyperplane finding problem for the ellipsoid ε(w,Q) is

$${min}_{u ∈ Λ * \backslash 0} {‖ {Q}^{- 1 / 2} [ \begin{matrix}u \\ 0\end{matrix} ] ‖}_{{P}_{{RQ}^{- 1 / 2}}} . \qquad ( 17 )$$

Hence we can now use the LLL-algorithm and its variants together with the GBR algorithm to compute a suitable u as in the case of PILP, with the difference that now the computations are being performed using a different projection matrix P_{RQ}_{^{−1/2}} and its approximations. The discussion on approximating Z* with Z^{F} where F is the set of fractional integer variables at the optimum solution of the relaxation problem continues to apply.

We can round the central point in (label 903) using the following procedure that is part of the present invention. The center of the ellipsoid w is rounded to a solution as follows. Let w_{z} be the components for the integer variables, and w_{c} be the components of the continuous variables. Let v be a solution such that Rv=r, where

$$v = [ \begin{matrix}{v}_{z} \\ {v}_{c}\end{matrix} ] ,$$

v_{z}∈ [symbol] ⁿ and v_{c}∈ [symbol] ^{\overline{n}}. Since v is not required to be non-negative, this v is easily computable by first finding a solution of Axₓ=a and then computing the corresponding x_{c}. Recall that C has a full row rank, so equations Cx_{c}b−Bv_{z} always has a solution. Clearly v_{z} statisfies Av_{z}=a. Since wₓ−v_{z}∈N(A), w_{z}−v_{z}=Zζ_{z} for some ζ_{z}∈ [symbol] ^{k}. Then \overline{v}_{z}=v_{z}+Z└ζ_{z}┐ is a rounded integer solution satisfying Ax_{z}=a. Here └ζ_{z}┐ represents an vector of integers that is nearest to ζ_{z} component-wise. We construct a solution \overline{v}=(\overline{v}_{z}, \overline{v}_{c}) of Rv=r by letting \overline{v}_{c} be a solution to the problem:

$${min}_{{x}_{c}} {( [ \begin{matrix}{\overline{v}}_{z} \\ {x}_{c}\end{matrix} ] - w )}^{T} Q ( [ \begin{matrix}{\overline{v}}_{z} \\ {x}_{c}\end{matrix} ] - w ) \\ s . t . B {\overline{v}}_{z} + C {x}_{c} = b . \qquad ( 18 )$$

If \overline{v} satisfies ∥w−\overline{v}∥_{Q}≦1, then a feasible solution is found; Otherwise, we can show that there exists a thin direction in an integral adjoint lattice Λ*. The following proposition shows that an ellipsoid in the original space is projected to an ellipsoid in the pure integer space. In order to ensure that either a mixed integer feasible solution is produced through the rounding or a good hyperplane can be found through a solution of problem (17) Z used in the above procedure and problem (18) must be LLL reduced in the ∥·∥_{\tilde{Q}} norm where \tilde{Q}=Q_{z}−Q_{zc}Q_{c}⁻¹Q_{zc}^{T}+(B−CQ_{c}⁻¹Q_{zc}^{T})^{T}(CQ_{c}⁻¹C^{T})⁻¹(B−CQ_{c}⁻¹Q_{zc}^{T}), and

$$Q = [ \begin{matrix}{Q}_{z} & {Q}_{zc} \\ {Q}_{zc}^{T} & {Q}_{c}\end{matrix} ] .$$

Approximate choices of \tilde{Q} and w are also considered as part of the present invention. In particular, we may use different choices of w (such as approximate centers, optimum solutions etc.), and possibly replace \tilde{Q} with an identity matrix.

### The Present Invention for Mixed Integer Convex Programming

The original Mixed Integer Convex Programming Problem (MICP)
minimize the objective: c₀(x)
satisfying constraints: Rx=r,
   cᵢ(x)≦0, for i=1, . . . , l.
   xᵢ is integer for i=1, . . . , n, xᵢ is real for i=n+1, . . . n+\overline{n}

Here we allow cᵢ(·) to be general non-differential convex functions, and use them to present conic constraints as well. Also cᵢ(·) may include differentiable and twice differentiable convex functions, and symmetric convex cones such as the cone of positive orthant xᵢ≧0, i=1, . . . , n+\overline{n}, second-order cone ∥\overline{x}∥≦x₁ where \overline{x} is the vector of all components of x except x₁, and the semidefinite cone requiring that the p×p matrix formed by p²=n+\overline{n} variable in the problem is a positive semidefinite matrix. We also allow the cartesian product of multiple such cones. Appropriate self concordant barriers are available for such cones (see Renegar 2001), and they allow for good approximations of the convex set defined by the constraints.

All the improvements of the present invention for PILP and MILP over the existing art are carried over to the present invention for MICP. We now describe further improvements that are described for MICP because of its more general structure (allowing continuous variables). This include the improvement of adding cutting planes at various nodes of the generalized-branch-and-bound tree for PILP, MILP, and MICP to develop a branch-and-cut algorithm.

The results of finding a good branching hyperplane for MILP also hold for all the results of the previous sections hold MICP provided that we can find a good ellipsoidal approximation of the continuous relaxation of the feasible set. The present invention is now described in the framework of a generalized-branch-and-cut algorithm. Besides the improvements discussed for PILP and MILP, this is a further improvement over the previous art, since the use of cutting planes has not been considered before for branch-and-cut algorithm with branching on hyperplane and half-spaces.

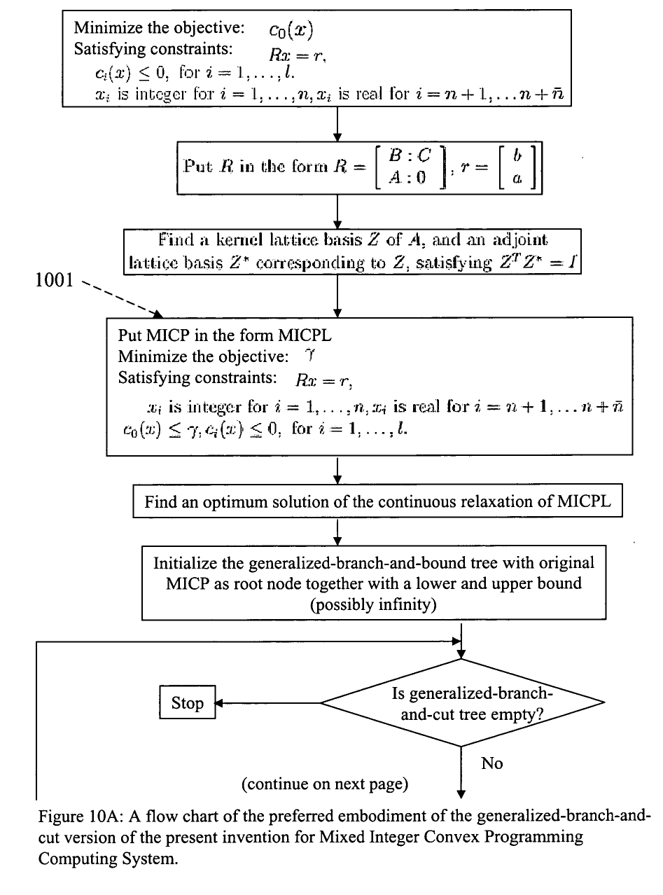

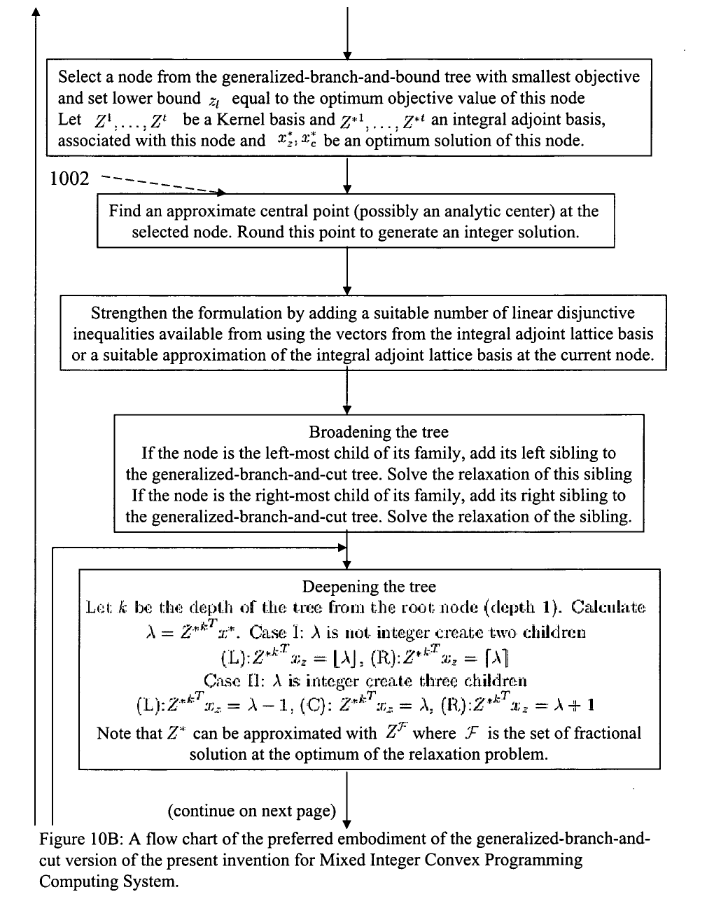

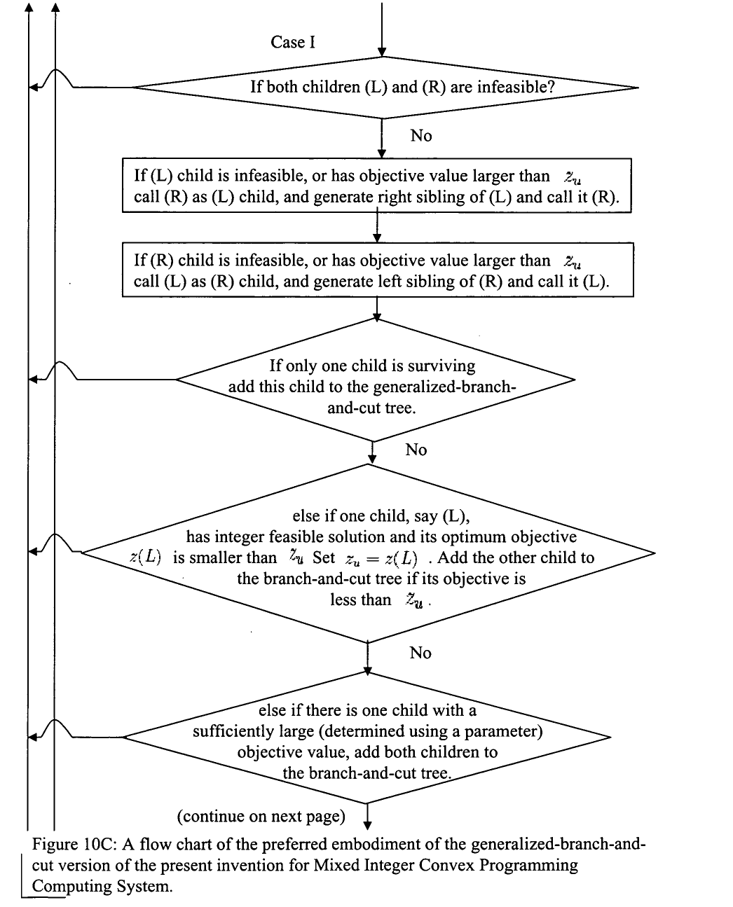

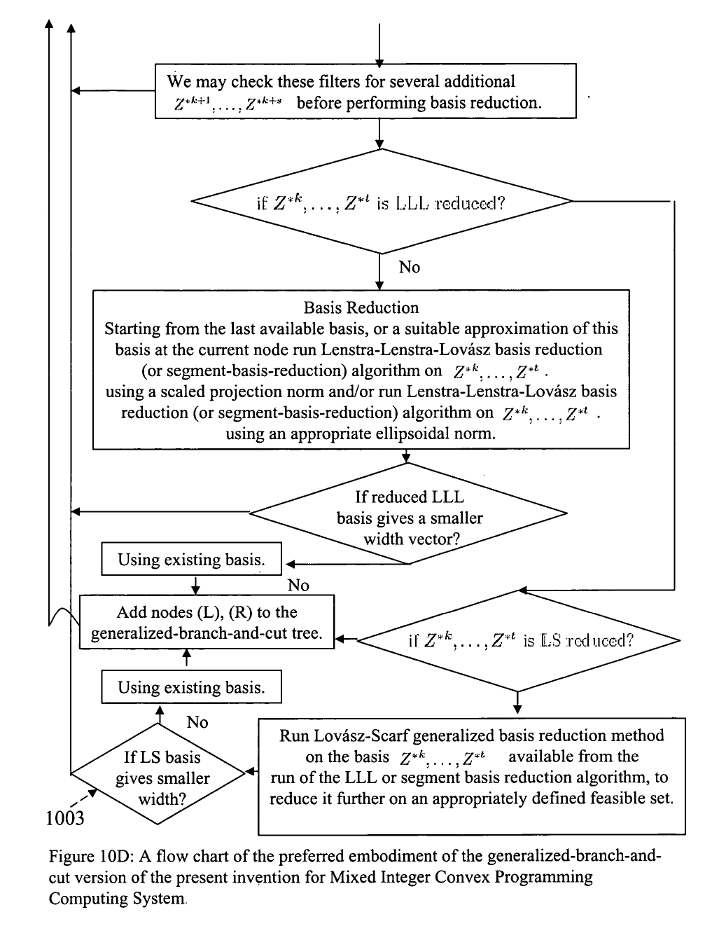

The branch-and-cut algorithm is developed first by converting MICP (as indicated by label 1001 in FIG. 10), to a problem where the objective function in MICP becomes part of the constraint set and the new problem MICPL has a linear objective. This is similar to the prescription of (Stubbs, et al. 1999). Solving MICP is equivalent to solving MICPL, however, MICPL has the advantage that it allows addition of cutting plane to strengthen the feasible set as the algorithm progresses. For simplicity we will assume that the variable γ is part of the vector x.

Let us consider (MICPL) and assume that the set Ĉ:={x|cᵢ(x)≦0, i=1, . . . , l+1} is bounded with a non-empty relative interior. The ellipsoidal approximation of a convex set requires a non-empty relative interior and boundedness assumption. We now address this issue. We have not made this approach part of our flow chart in FIG. 10 because it makes the flow chart unnecessarily cumbersome.

To compute a center and ellipsoidal approximation of the set we use a two-phase approach. In the first phase we compute a feasible interior solution using an interior point algorithm of choice, and in the second phase we use this interior solution as a starting point to get a suitable approximation of the analytic center. The feasibility problem is given by
min{xₐ|Rx=r, cᵢ(x)−(cᵢ(x⁰)+κ)xₐ≦0, i=1, . . . , l} (19)

where xₐ is an artificial variable, x⁰ is any point satisfying Rx⁰=r, and κ is a suitably large constant that ensures appropriate initial condition ((x⁰, 1) being close to the central path for the path following primal interior point methods). A point (x*, X*ₐ) is found via an interior point algorithm (for example the path following and primal-dual algorithms in (Nesterov and Nemirovskii 1994) or (Renegar 2001) in the differential case where functions admit strongly self-concordance properties, or the algorithms in (Anstreicher 1999, Anstreicher (1998)) is adapted for equality constraints compute an approximate center and a matrix Q that allows us to approximate the convex) applied to problem (19) satisfying one of the three criteria: (i) a point (x*, 0) satisfying Rx*=r, cᵢ(x*)<0, i=1, . . . , l, (ii) a proof that the optimum objective value of (19), x*ₐ, is greater than \hat{ε}>0, or (iii) X*ₐ≦\hat{ε}. In case (i) we use x* as a starting point and apply damped Newton iterations to obtain \tilde{w}. In case (ii) we have an infeasible node. In case (iii) within tolerance at the current node we are unable to verify if the problem is infeasible or if it has a non-empty interior. In this case we work with the approximate set
\tilde{C}:={x|Rx=r, cᵢ(x)−2(cᵢ(x⁰)+κ)\hat{ε}≦0, i=1, . . . , l}

for which x* is a feasible interior solution, and find an approximate analytic center \tilde{w} of the set \tilde{C}. If ε≦2(cᵢ(x⁰)+K)\hat{ε}, we are now working with ε—MICPL. In certain special situations, such as in the case of MILP, we may add additional hyperplanes to the original set of constraints to ensure that the relative interior of the new problem is non-empty. The information is this is available through the convergence properties of interior point methods (Mehrotra, et al. 1993).

We use an approximation of analytic center from the above process in step 1002 and the associated barrier Hessian (or an approximation to the Vaidya center and the Hessian of the volumetric barrier for the non-differentiable or differentiable but poor quality convex function case) to generate the desired ellipsoidal approximation. This is subsequently used to generate the branching hyperplanes/half-spaces in Lenstra-type algorithm, and a nearby rounded solution. Note that if a feasible solution to \tilde{C} is found, then it is within a small perturbation (given with the choice of ε) of set C; otherwise, the number of branching hyperplanes is bounded by a constant determined by the dimension of the problem. In special cases such as problems defined over symmetric cones and linear constraints use of primal-dual methods is more appropriate for computing the analytic center. The use of two-phase approach or the use of primal-dual interior point methods is not part of previous art for solving MICPL. The use of such methods to generate an analytic center for the convex set with equality constraints in the context of generalized-branch-and-cut algorithms for MICP is considered part of the present invention.

The step of testing the quality of a Lovász-Scarf reduced lattice basis using their generalized basis reduction (GBR) algorithm basis (labelled 808 in FIG. 8 and labelled 1003 in FIG. 10) is particularly important in the MICPL setting setting since the GBR algorithm requires an exact solution of a convex program to compute distance functions. This is not possible for general convex programming problems. Since LLL-type algorithms work with only an ellipsoidal approximation the precision of the arithmetic operations can be specified in advance, and a theoretically correct algorithm is implemented as desired (see for example, Lenstra, et al. 1982, Koy et al. 2001, Mehrotra, et al. 2004).

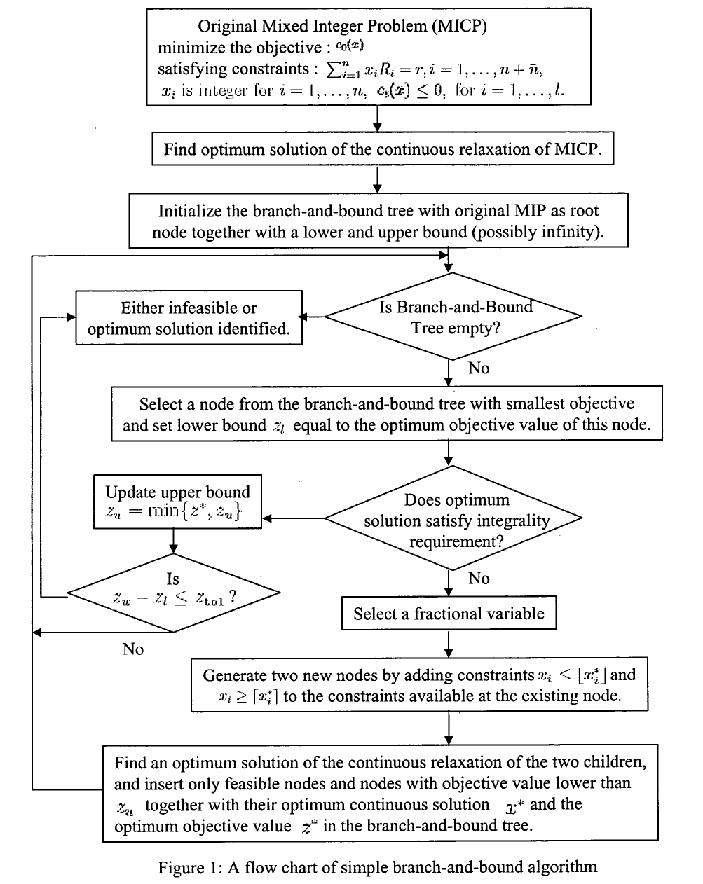

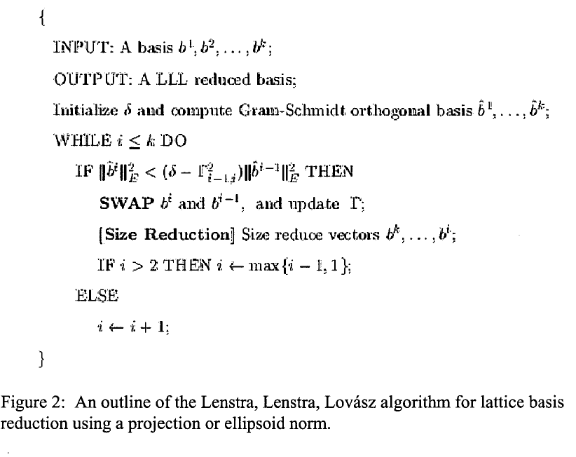

In order to strengthen the problem formulation at a node (possibly root node) of the generalized-branch-and-bound tree we further consider the use of a projection problem to generate inequalities that provide constraints (cuts) which cut away the infeasible solutions for MICPL, but do not cut away the mixed integer feasible solutions. Such strengthening of problem formulation is common in the current art to improve the branch-and-bound algorithm of FIG. 1 (see Nemhauser, et al. 1998 and Wolsey (1998)). However, they are not a part of the known art of using generalized-branch-and-bound algorithms. We describe improvement of the art for the generalized-branch-and-bound algorithm to include this case. This is achieve through the solution of a projection problem in the general setting of MICPL. The projection problems are described as follows. Let \overline{x} be a solution of the continuous relaxation of a MICPL at a particular node of the generalized-branch-and-cut tree. The art of the present invention considers the disjunctive program:

$$min ‖ x - \overline{x} ‖ \\ x = {λ}^{1} {y}^{1} + {λ}^{2} {y}^{2} \\ \{ {y}^{1} ∈ \tilde{C} , {u}^{T} {y}^{1} \leq β \} , \{ {y}^{2} ∈ \tilde{C} , {u}^{T} {y}^{2} \geq β + 1 \} \\ {λ}^{1} + {λ}^{2} = 1 , {λ}^{1} , {λ}^{2} \geq 0 , \qquad ( 20 )$$

where ∥·∥ is a suitable norm 1-norm or ∞-norm. The vector u is any general vector (possibly vectors from the reduced integral adjoint lattices, or [symbol] ^{F} lattice). The above disjunctive program is further reformulated into a convex program by making the perspective transformation (see Stubbs, et al. 1999) x¹=π¹y¹ and x²=λ²y², and substituting for the variables y¹ and y² (Note that the constraints describing \tilde{C} are now written using variables y¹ and y²) in the constraints describing this disjunctive program. A final variable multiplication step is performed for all the constraints to further convert a problem obtained in this way to a convex program. In particular, a constraint cᵢ(x¹/λ¹)≦0 is converted to a convex constraint by writing it as λ¹cᵢ(x¹/λ¹)≦0. This process is repeated for all the constraints. A further variable elimination of λ¹ or λ² is possible by using the equality λ¹+λ²=1. The resulting convex program (or in the linear case its dual) is then solved. The gradient (or subgradient) of the objective in this disjunctive program at its optimum solution provides a desired separating inequality. This process may be repeated for several different choices of u (it may be a vector of all zeros, and a one corresponding to a fractional variables, or columns of integral adjoint lattice basis). Furthermore, multiple disjunctions are used in the same disjunctive program to generate cutting planes to strengthen the formulations. This is achieved by writing the constraints in (21) for each choice of u giving its own variables y¹ and y², but keeping x common. More precisely, let u¹, . . . u^{t} be the lattice vectors which are desired in the disjunctive program. Then the separation problem becomes:

$$min ‖ x - \overline{x} ‖ \\ x = {λ}^{1 , j} {y}^{1 , j} + {λ}^{2 , j} {y}^{2 , j} \\ \{ {y}^{1 , j} ∈ \tilde{C} , {u}^{{j}^{T}} {y}^{1 , j} \leq {β}^{j} \} , \{ {y}^{2 , j} ∈ \tilde{C} , {u}^{{j}^{T}} {y}^{2 , j} \geq {β}^{j} + 1 \} , \\ {λ}^{1 , j} + {λ}^{2 , j} = 1 , {λ}^{1} , {λ}^{2} \geq 0 , j = 1 , … , t . \qquad ( 21 )$$

This problem is written as a convex program using the technique from Stubbs, et al. (1999) described above. In case of structured problems, such as combinatorial problems (see Nemhauser, et al. 1998) additional inequalities are generated and added to the node under consideration that exploit the combinatorial structure of the problem. The techniques of generating these inequalities depend on the problem structure and is part of the existing art.

### Computational Performance of an Embodiment of the Invention

To demonstrate the performance of the present invention, two datasets were used. Similar datasets have been used earlier in the field as test problems. The comparisons are made with the performance of a commercial mixed integer programming computing software (CPLEX) running on the same platform. The first set of problems are the integer knapsack problems provided to us by used in (Aardal, et al. 2002). The data for these problems problems is given in Table 2. Here we need to find if there is a nonnegative integer vector x, which will give the Frobenius number a₀ when multiplied with a.

The second set of test problems are the market split problems based on (Cornuéjols et al. 1998), and studied by (Aardal, et al. 1999). The market split problems were introduced by Cornuéjols and Dawande (1998). The binary version of these problems is described as follows. This description is taken from (Aardal et al. 1999). A company with two divisions supplies retailers with several products. The goal is to allocate each retailer to one of the divisions such that division 1 controls 100αᵢ% of the market share, and division 2 controls the remaining 100(1−αᵢ)% market share. Here 0≦αᵢ<1. There are m retailers and n≦m products. Let a_{i,j} be the demand of retailer j for product i, and let dᵢ be determined as └αᵢd′ᵢ┘, where d′ᵢ is the amount of product i that is supplied to the retailers. The decision variable xⱼ takes value 1 if retailer j is allocated to division j, and zero otherwise. The problem is to decide an allocation of the retailers to the divisions such that the desired market split is obtained. The problem can be formulated as follows
MSP: Find xε∈ [symbol] ⁿs.t. Ax=d,

where A is a matrix whose i,j coefficient is [a_{i,j}]. We generated these test problems randomly following the above description from (Aardal et al. 1999). We let n=10(m−1) and let the coefficients of A be integer numbers uniformly and independently drawn from the interval [0, D]. We generated problems by taking D=100 as in (Aardal et al. 1999). The right-hand-side coefficients are computed as dᵢ=└½Σⱼ₌₁ⁿa_{i,j}┘, 1≦i≦m. A market split among retailers takes place if we take αᵢ=½, i=1, . . . , m. Cornuéjols, et al. (1998) argued that most of the problems generated in this way are infeasible, and observed that

TABLE 2
Hard Knapsack Problems

| Program | α coefficients | Frobenius number α₀ |
|---|---|---|
| Law1 | 12223 12224 36674 61119 85569 | 89643481 |
| Law2 | 12228 36679 36682 48908 61139 73365 | 89716838 |
| Law3 | 12137 24269 36405 36407 48545 60683 | 58925134 |
| Law4 | 13211 13212 39638 52844 66060 79268 92482 | 104723595 |
| Law5 | 13429 26850 26855 40280 40281 53711 53714 67141 | 45094583 |
| Problem1 | 25067 49300 49717 62124 87608 88025 113673 119169 | 33367335 |
| Problem2 | 11948 23330 30635 44197 92754 123389 136951 140745 | 14215206 |
| Problem3 | 39559 61679 79625 99658 133404 137071 159757 173977 | 58424799 |
| Problem4 | 48709 55893 62177 65919 86271 87692 102881 109765 | 60575665 |
| Problem5 | 28637 48198 80330 91980 102221 135518 165564 176049 | 62442884 |
| Problem6 | 20601 40429 40429 45415 53725 61919 64470 69340 78539 95043 | 22382774 |
| Problem7 | 18902 26720 34538 34868 49201 49531 65167 66800 84069 137179 | 27267751 |
| Problem8 | 17035 45529 48317 48506 86120 100178 112464 115819 125128 129688 | 21733990 |
| Problem9 | 3719 20289 29067 60517 64354 65633 76969 102024 106036 119930 | 13385099 |
| Problem10 | 45276 70778 86911 92634 97839 125941 134269 141033 147279 153525 | 106925261 |
| Problem11 | 11615 27638 32124 48384 53542 56230 73104 73884 112951 130204 | 577134 |
| Problem12 | 14770 32480 75923 86053 85747 91772 101240 115403 137390 147371 | 944183 |
| Problem13 | 15167 28569 36170 55419 70945 74926 95821 109046 121581 137695 | 765260 |
| Problem14 | 1828 14253 46209 52042 55987 72649 119704 129334 135589 138360 | 680230 |
| Problem15 | 13128 37469 39391 41928 53433 59283 81669 95339 110593 131989 | 663281 |
| Problem16 | 35113 36869 46647 53560 81518 85287 102780 115459 146791 147097 | 1109710 |
| Problem17 | 14054 22184 29952 64696 92752 97364 118723 119355 122370 140050 | 752109 |
| Problem18 | 20303 26239 33733 47223 55486 93776 119372 136158 136989 148851 | 783879 |
| Problem19 | 20212 30662 31420 49259 49701 62688 74254 77244 139477 142101 | 677347 |
| Problem20 | 32663 41286 44549 45674 95772 111887 117611 117763 141840 149740 | 1037608 |

the standard branch-and-bound used to solve the problems requires 2^{γn} nodes, where γ was approximately 0.6.

In addition to the above described versions of the problem, we create another set of problems from the same data. In this set we allow x to take non-negative integer values, instead of just the binary values. By allowing problem variables to take general integer values, several of the problems become feasible. These problems are generally significantly harder than their binary versions. In all cases the sum Σᵢ₌₁ⁿxᵢ is used as an objective. Table 3 shows the statistics for the problems we have managed to solve. The market split problems are named as mspnm. The general integer version of the market split problems are indicated by “Gen”. All problems are pure integer programming problems.

The integral adjoint lattice concept allows several alternative embodiments of the present invention. Computational results are reported on the use of integral adjoint lattice in following embodiments: (i) computing LLL-reduced lattices by taking Q=I at the root node (LLL-l₂) and no further lattice basis reduction; (ii) computing a reduced lattice basis using either the LLL-reduced lattice at the root node (LLL-R) using the actual Q at the root node, and no further lattice basis reduction. (iii) use the GBR algorithm only at the root node (GBR-R), and no further lattice basis reduction. (iv) working with an ellipsoidal approximation of P and using the LLL algorithm at every node (LLL-E) without using the filtering steps 805-813 in FIG. 8; (v) working with P and computing the GBR algorithm at every node (GBR-E), without using the filtering steps 805-815 in FIG. 8.

Tables 4, 5, and 6 give the number of nodes (#N) required to solve the knapsack and market split problems respectively. The columns of “#T” give the maximum tree size during the solution time. These results are obtained by using δ=0.99 and ε=0.1 in the basis reduction algorithms under different settings described above. These tables also report the number of nodes in the branch-and-bound tree required by CPLEX version 8.0 to solve these problems. A “+” notation at the end of a number indicates that CPLEX version 8.0 exhausted all computer memory or failed after generating the given number of nodes, or the maximum allocated time exceeded. It is obvious that for these problem sets the LLL-R and LLL-L2 embodiments of the new art significantly (several orders of magnitude) out-performed the existing art both in terms of computational time requirements, and memory requirements.

For many problems the implementation of the GBR algorithm failed to produce meaningful results for several problems in both GBR-R and GBR-E runs. These failures were traced to the continuous optimization solvers incapability in generating solutions with required precision for the GBR algorithm. Generating stable results using LLL-l₂, LLL-R,

TABLE 3
Market Share Problem (B = Bineary, G = General)

| Program | #Cols | #Rows | Solution Status | Variable Type |
|---|---|---|---|---|
| msp21-25 | 10 | 2 | ∞ | B |
| msp31-35 | 20 | 3 | ∞ | B |
| msp43 | 30 | 4 | 14 | B |
| msp41, 42, 44 | 30 | 4 | ∞ | B |
| msp51, 54 | 40 | 5 | 20 | B |
| msp52, 53, 55 | 40 | 5 | ∞ | B |
| msp61, 64 | 50 | 6 | 25 | B |
| msp62, 63 | 50 | 6 | ∞ | B |
| msp65 | 50 | 6 | 24 | B |
| msp71-73 | 60 | 7 | 30 | B |
| msp74 | 60 | 7 | ∞ | B |
| msp75 | 60 | 7 | 29 | B |
| msp21Gen, 22, 25 | 10 | 2 | ∞ | G |
| msp23Gen | 10 | 2 | 13 | G |
| msp24Gen | 10 | 2 | 16 | G |
| msp31Gen | 20 | 3 | 9 | G |
| msp32Gen | 20 | 3 | 11 | G |
| msp33Gen | 20 | 3 | 8 | G |
| msp34Gen, 35 | 20 | 3 | 10 | G |
| msp41Gen, 44 | 30 | 4 | 14 | G |
| msp42Gen, 43, 45 | 30 | 4 | 13 | G |
| msp51Gen, 52, 54, 55 | 40 | 5 | 17 | G |
| msp53Gen | 40 | 5 | 16 | G |
| msp61Gen, 65 | 50 | 6 | 21 | G |
| msp62Gen, 63, 64 | 50 | 6 | 22 | G |

and LLL-E required the use of extended precision for some problems, but over all these runs were more stable than GBR based runs. Hence confirming our logic that we need to check the results from GBR for a stable mixed integer programming computing system.

Based on these computational results we conclude the following. First, branching on hyperplane algorithms is an invaluable tool for solving difficult binary and general integer programming problems, and for problems in our testset it outperforms both in time and space requirements when compared to the current art as available through a commercial solver. Stable implementations of these algorithms using integral adjoint lattices and kernel lattices are demonstrated.

Another important conclusion is that in a preferred embodiment it is not necessary to perform lattice basis reduction at each node of the branch-and-bound tree, and the hierarchical approach has demonstrable value. For the general integer versions of the market split problem, the lattices produced by performing basis reduction by using the approximate norm Q=I frequently solved problems with fewer number of nodes than the lattices produced when Q was used. This shows that the approach that progressively solve a harder problem may not always provide superior solutions, hence the safeguards and comparison checks presented as part of the present invention play a useful role.

### Mixed Integer Programming Computing System

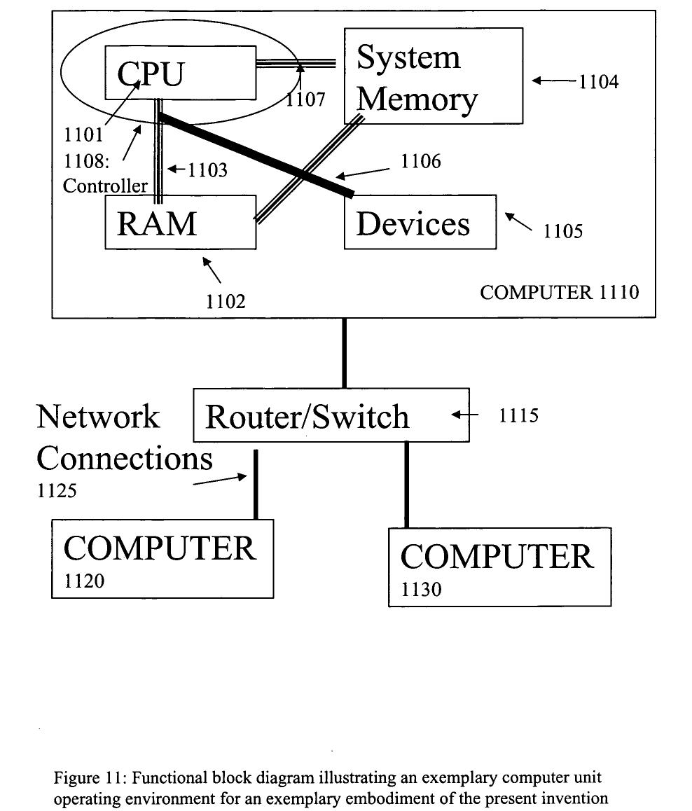

The hierarchical lattice basis reduction based generalized-branch-and-cut method of the present invention can be ustilized for a a wide range of mixed integer programming based computing systems. In an exemplary embodiment the generalized-branch-and-bound method is used for solutions of knapsack and market split problems. A suitable computing environment for implementing the exemplary mixed integer programming computing system is illustrated in FIG. 11. The computer 1110 includes a central processing unit 1101, a system memory 1104, an Input/Output (“I/O”) bus 1103, a system bus coupling the CPU with system memory 1107. A bus controller 1108 controls the flow of data on the I/O bus 1103 between CPU 1101 and a variety of internal and external devices 1105. The I/O devices connected to the I/O bus 1103 may have direct access to the system memory 1104 using a direct memory access (DMA) controller.

The I/O devices are connected to the I/O bus 1103 via a set of device interfaces. The device interfaces may include both hardware components and software components. For instance, a hard disk drive, a floppy disk drive, or a tape drive, a zip drive or a CD-ROM drive may be connected to the I/O bus 1103. A display device, such as a monitor, is connected to the I/O bus via an interface such as a video adapter. And parallel interfaces such as parallel ports and universal serial bus ports (USB) connect devices such as laser printer to

TABLE 4
Comparison of Branching Schemes for Hard Knapsack Problems (MN stands for one million)

| | LLL-L2 | | LLL-Ellip-R | | LLL-Ellip-E | | GBR-R | | GBR-E | | GBROnly-R | | GBROnly-E | | CPLEX |
|---|---|---|---|---|---|---|---|---|---|---|---|---|---|---|---|
| Program | #N | #T | #N | #T | #N | #T | #N | #T | #N | #T | #N | #T | #N | #T | #N |
| Law1 | 1 | 1 | 1 | 1 | 1 | 1 | 1 | 1 | 1 | 1 | 1 | 1 | 1 | 1 | 50 MN |
| Law2 | 1 | 1 | 1 | 1 | 1 | 1 | 1 | 1 | 1 | 1 | 1 | 1 | 1 | 1 | 2586612 |
| Law3 | 3 | 1 | 3 | 1 | 3 | 1 | 3 | 1 | 3 | 1 | 3 | 1 | 3 | 1 | 50 MN |
| Law4 | 1 | 1 | 1 | 1 | 1 | 1 | 1 | 1 | 1 | 1 | 1 | 1 | 1 | 1 | 50 MN |
| Law5 | 1 | 1 | 1 | 1 | 1 | 1 | 1 | 1 | 1 | 1 | 1 | 1 | 1 | 1 | 50 MN |
| Problem1 | 3 | 1 | 3 | 1 | 3 | 1 | 3 | 1 | 3 | 1 | 3 | 1 | 3 | 1 | 50 MN |
| Problem2 | 6 | 3 | 3 | 1 | 5 | 2 | 3 | 1 | 3 | 1 | 3 | 1 | 3 | 1 | 50 MN |
| Problem3 | 8 | 5 | 5 | 3 | 3 | 1 | 5 | 3 | 3 | 1 | 5 | 3 | 3 | 1 | 50 MN |
| Problem4 | 5 | 3 | 3 | 1 | 3 | 1 | 3 | 1 | 3 | 1 | 3 | 1 | 3 | 1 | 50 MN |
| Problem5 | 5 | 3 | 6 | 3 | 3 | 1 | 6 | 3 | 3 | 1 | 6 | 3 | 3 | 1 | 50 MN |
| Problem6 | 3 | 1 | 3 | 1 | 5 | 3 | 3 | 1 | 3 | 1 | 3 | 1 | 3 | 1 | 50 MN |
| Problem7 | 5 | 3 | 5 | 3 | 3 | 1 | 5 | 3 | 3 | 1 | 5 | 3 | 3 | 1 | 50 MN |
| Problem8 | 3 | 1 | 3 | 1 | 3 | 1 | 3 | 1 | 3 | 1 | 3 | 1 | 3 | 1 | 50 MN |
| Problem9 | 8 | 4 | 11 | 8 | 7 | 4 | 5 | 3 | 3 | 1 | 5 | 3 | 3 | 1 | 50 MN |
| Problem10 | 3 | 1 | 3 | 1 | 7 | 5 | 3 | 1 | 3 | 1 | 3 | 1 | 3 | 1 | 50 MN |
| Problem11 | 39 | 23 | 22 | 17 | 15 | 13 | 23 | 19 | 19 | 15 | 23 | 19 | 19 | 17 | 56,130 |
| Problem12 | 52 | 32 | 20 | 15 | 19 | 16 | 18 | 13 | 19 | 14 | 18 | 13 | 17 | 12 | 82,972 |
| Problem13 | 48 | 30 | 17 | 14 | 10 | 7 | 21 | 14 | 19 | 12 | 21 | 14 | 19 | 14 | 100,172 |
| Problem14 | 58 | 37 | 15 | 12 | 19 | 15 | 18 | 13 | 20 | 13 | 18 | 13 | 16 | 11 | 70,208 |
| Problem15 | 34 | 21 | 28 | 17 | 17 | 12 | 35 | 29 | 24 | 13 | 35 | 29 | 24 | 16 | 80,624 |
| Problem16 | 46 | 31 | 21 | 14 | 15 | 10 | 30 | 23 | 15 | 9 | 30 | 23 | 15 | 9 | 484,564 |
| Problem17 | 39 | 29 | 24 | 16 | 21 | 17 | 27 | 19 | 24 | 17 | 27 | 19 | 22 | 17 | 62,792 |
| Problem18 | 58 | 32 | 29 | 23 | 11 | 7 | 29 | 22 | 17 | 12 | 29 | 22 | 15 | 11 | 110,711 |
| Problem19 | 57 | 38 | 32 | 21 | 21 | 13 | 34 | 23 | 22 | 15 | 34 | 23 | 22 | 16 | 116,304 |
| Problem20 | 27 | 18 | 21 | 18 | 14 | 11 | 20 | 17 | 13 | 11 | 20 | 17 | 13 | 11 | 230,562 |

TABLE 5
Comparison of Branching Schemes for Binary Version of Market Split Problems

| | LLL-L2 | | LLL-Ellip-R | | LLL-Ellip-E | | GBR-R |
|---|---|---|---|---|---|---|---|
| Program | #N | #T | #N | #T | #N | #T | #N |
| msp21 | 1 | 1 | 1 | 1 | 1 | 1 | 1 |
| msp22 | 1 | 1 | 1 | 1 | 1 | 1 | 1 |
| msp23 | 1 | 1 | 1 | 1 | 1 | 1 | 1 |
| msp24 | 1 | 1 | 1 | 1 | 1 | 1 | 1 |
| msp25 | 1 | 1 | 1 | 1 | 1 | 1 | 1 |
| msp31 | 5 | 2 | 5 | 2 | 5 | 2 | 3 |
| msp32 | 3 | 1 | 3 | 1 | 5 | 2 | 7 |
| msp33 | 3 | 1 | 3 | 1 | 5 | 2 | 7 |
| msp34 | 3 | 1 | 3 | 1 | 3 | 1 | 7 |
| msp35 | 7 | 5 | 7 | 5 | 7 | 4 | 5 |
| msp41 | 43 | 34 | 43 | 34 | 111 | 77 | 169 |
| msp42 | 70 | 56 | 70 | 56 | 127 | 101 | 152 |
| msp43 | 10 | 11 | 10 | 11 | 38 | 43 | 73 |
| msp44 | 70 | 59 | 70 | 59 | 77 | 59 | 125 |
| msp45 | 54 | 40 | 54 | 40 | 81 | 72 | 62 |
| msp51 | 445 | 435 | 445 | 435 | 2,462 | 2,125 | 2,358 |
| msp52 | 1,060 | 776 | 1,060 | 776 | 3,236 | 2,083 | 2,000 |
| msp53 | 2,755 | 2,117 | 2,755 | 2,117 | 3,257 | 2,048 | 5,147 |
| msp54 | 2,287 | 1,884 | 2,287 | 1,884 | 2,296 | 1,722 | |
| msp55 | 1,112 | 889 | 1,112 | 889 | 4,217 | 2,737 | |
| msp61 | 67,479 | 60,614 | 67,479 | 60,164 | 128,362 | 91,049 | |
| msp62 | 52,199 | 41,606 | 52,199 | 41,606 | | | |
| msp63 | 125,770 | 95,845 | 125,770 | 95,845 | | | |
| msp64 | 57,548 | 60,074 | 57,548 | 60,074 | | | |
| msp65 | 42,815 | 49,259 | 41,815 | 49,259 | | | |
| msp71 | 7,338,206 | 7,040,443 | 7,338,206 | 7,040,443 | | | |
| msp72 | 4,310,763 | 4,398,331 | 4,310,763 | 4,398,331 | | | |
| msp73 | 5,552,473 | 5,108,454 | 5,552,473 | 5,108,454 | | | |
| msp74 | 4,297,378 | 3,248,960 | 4,297,378 | 3,248,960 | | | |
| msp75 | 1,317,059 | 1,564,783 | 1,317,059 | 1,564,783 | | | |

| | | GBR-E | | GBROnly-R | | GBROnly-E | | CPLEX |
|---|---|---|---|---|---|---|---|---|
| Program | #T | #N | #T | #N | #T | #N | #T | #N |
| msp21 | 1 | 1 | 1 | 1 | 1 | 1 | 1 | 53 |
| msp22 | 1 | 1 | 1 | 1 | 1 | 1 | 1 | 22 |
| msp23 | 1 | 1 | 1 | 1 | 1 | 1 | 1 | 14 |
| msp24 | 1 | 1 | 1 | 1 | 1 | 1 | 1 | 0 |
| msp25 | 1 | 1 | 1 | 1 | 1 | 1 | 1 | 30 |
| msp31 | 1 | 11 | 8 | 3 | 1 | 7 | 5 | 7,357 |
| msp32 | 4 | 9 | 4 | 7 | 4 | 7 | 5 | 6,912 |
| msp33 | 5 | 7 | 5 | 7 | 5 | 7 | 5 | 6,251 |
| msp34 | 5 | 7 | 3 | 7 | 5 | 7 | 5 | 9,745 |
| msp35 | 3 | 9 | 4 | 5 | 3 | 5 | 3 | 6,067 |
| msp41 | 153 | 107 | 73 | 169 | 153 | 159 | 139 | 674,038 |
| msp42 | 129 | 343 | 221 | 152 | 129 | 161 | 151 | 405,467 |
| msp43 | 89 | 28 | 36 | 73 | 89 | 39 | 66 | 27,865 |
| msp44 | 105 | 163 | 119 | 125 | 105 | 111 | 94 | 426,512 |
| msp45 | 62 | 84 | 67 | 62 | 62 | | | 334,316 |
| msp51 | 2,378 | | | 2,358 | 2378 | | | 139,324,538 |
| msp52 | 1,617 | | | 2,000 | 1,617 | | | 187,051,878 |
| msp53 | 3,817 | | | 5,147 | 3,817 | | | 223,035,636 |
| msp54 | | | | | | | | 105,217,180 |
| msp55 | | | | | | | | 87,168,546 |
| msp61 | | | | | | | | |
| msp62 | | | | | | | | |
| msp63 | | | | | | | | |
| msp64 | | | | | | | | |
| msp65 | | | | | | | | |
| msp71 | | | | | | | | |
| msp72 | | | | | | | | |
| msp73 | | | | | | | | |
| msp74 | | | | | | | | |
| msp75 | | | | | | | | |

TABLE 6
Comparison of Branching Schemes for General Integer Version of Market Split Problems

| | LLL-L2 | | LLL-Ellip-R | | LLL-Ellip-E | | GBR-R | |
|---|---|---|---|---|---|---|---|---|
| Program | #N | #T | #N | #T | #N | #T | #N | #T |
| msp21Gen | 1 | 1 | 1 | 1 | 1 | 1 | 3 | 1 |
| msp22Gen | 5 | 3 | 3 | 1 | 3 | 1 | 5 | 3 |
| msp23Gen | 8 | 7 | 4 | 2 | 4 | 2 | 5 | 3 |
| msp24Gen | 5 | 3 | 12 | 8 | 5 | 3 | 7 | 4 |
| msp25Gen | 3 | 1 | 3 | 1 | 3 | 1 | 3 | 1 |
| msp31Gen | 19 | 26 | 24 | 40 | 35 | 43 | 38 | 55 |
| msp32Gen | 35 | 36 | 48 | 43 | 45 | 38 | 67 | 65 |
| msp33Gen | 12 | 27 | 37 | 53 | 76 | 88 | 27 | 51 |
| msp34Gen | 38 | 56 | 25 | 31 | 25 | 16 | 33 | 20 |
| msp35Gen | 29 | 22 | 54 | 51 | 41 | 37 | 29 | 37 |
| msp41Gen | 408 | 785 | 4,037 | 3,678 | 2,101 | 1,870 | 853 | 831 |
| msp42Gen | 386 | 704 | 3,519 | 3,182 | 1,457 | 997 | 762 | 1,214 |
| msp43Gen | 156 | 306 | 2,587 | 4,249 | 531 | 319 | 249 | 535 |
| msp44Gen | 595 | 808 | 1,046 | 962 | 1,003 | 1,127 | 532 | 691 |
| msp45Gen | 431 | 617 | 900 | 1,654 | 551 | 699 | 263 | 464 |
| msp51Gen | 968 | 2,700 | 153,365 | 215,147 | | | 22,550 | 49,064 |
| msp52Gen | 5,013 | 9,982 | 44,316 | 73,233 | | | | |
| msp53Gen | 1,655 | 3,956 | 3,619 | 6,491 | | | 3,021 | 6,476 |
| msp54Gen | 12,632 | 25,252 | 451,322 | 497,484 | | | 13,080 | 33,017 |
| msp55Gen | 3,686 | 9,041 | 209,093 | 266,995 | | | 19,336 | 35,876 |
| msp61Gen | 737,472 | 1,730,076 | 1,333,459 | 1,813,507 | | | | |
| msp62Gen | 615,398 | 1,341,813 | 1,112,669 | 1,627,837 | | | | |
| msp63Gen | 1,289,547 | 2,417,073 | 10,985,185 | 11,466,850 | | | | |
| msp64Gen | 464,568 | 417,131 | 5,331,773 | 5,805,908 | | | | |
| msp65Gen | 341,099 | 815,466 | 5,801,220 | 9,162,375 | | | | |

| | GBR-E | | GBROnly-R | | GBROnly-E | | CPLEX |
|---|---|---|---|---|---|---|---|
| Program | #N | #T | #N | #T | #N | #T | #N |
| msp21Gen | 3 | 1 | 3 | 1 | 3 | 1 | 300 |
| msp22Gen | 3 | 1 | 5 | 3 | 3 | 1 | 319 |
| msp23Gen | 5 | 3 | 5 | 3 | 5 | 3 | 296 |
| msp24Gen | 3 | 1 | 7 | 4 | 7 | 5 | 216 |
| msp25Gen | 3 | 1 | 3 | 1 | 3 | 1 | 203 |
| msp31Gen | 20 | 24 | 38 | 55 | 17 | 18 | 52,309 |
| msp32Gen | 37 | 38 | 67 | 65 | 35 | 34 | 217,282 |
| msp33Gen | 24 | 33 | 27 | 51 | 26 | 43 | 10,348 |
| msp34Gen | 25 | 21 | 33 | 30 | 27 | 22 | 16,619 |
| msp35Gen | 46 | 46 | 29 | 37 | 24 | 24 | 39,024 |
| msp41Gen | | | 855 | 831 | | | 2,300,535 |
| msp42Gen | | | 762 | 1,214 | | | 6,709,815 |
| msp43Gen | | | 249 | 535 | | | 3,231,977 |
| msp44Gen | | | 532 | 691 | | | 3,139,026 |
| msp45Gen | | | 263 | 464 | | | 5,872,371 |
| msp51Gen | | | 22,550 | 49,064 | | | 7,353,400 |
| msp52Gen | | | | | | | 55,510,742 |
| msp53Gen | | | 3,021 | 6,476 | | | 28,715,054 |
| msp54Gen | | | 13,080 | 33,017 | | | 38,776,979* |
| msp55Gen | | | 19,336 | 35,876 | | | 44,591,970* |
| msp61Gen | | | | | | | |
| msp62Gen | | | | | | | |
| msp63Gen | | | | | | | |
| msp64Gen | | | | | | | |
| msp65Gen | | | | | | | |

the I/O bus. The system may also have a mouse and an keyboard device interface connect through a separate port or a USB port. In addition the system may have peripheral devices such as audio input/output devices and image and video capturing devices connected to I/O bus and bus controller through different ports. These devices are not shown in FIG. 11.

A number of program modules may be stored on the drives and the system memory 1104. The system memory 1104 can include both Random Access Memory (RAM) (shown separately) and read only memory (ROM). The program module control ho the computer 1110 functions and interacts with the user, with I/O devices or with other computer programs, and other computers. Program modules include routines, operating systems, application programs, data structures, and other software or firmware components. In an illustrative embodiment, the mixed integer programming computing system may comprise one or more pre-processing and post-processing program modules stored on devices or in the system memory of the computer 1110. A plurality of mixed integer programming computing systems can be configured to hierarchically process multiple data sets in parallel or sequentially. Specifically, pre-processing program modules, post-processing program modules, together with mixed integer programming program modules may comprise computer-executable instructions for reading and pre-processing data and post-processing and displaying output from a mixed integer programming computing system.

The computer 1110 may operate in a networked environment using logical connections 1125 to one or more local and remote computers, such as remote computers 1115, 1120, or 1130 through a local area network (LAN) and a wide area network (WAN). The remote computer 1115 may be a server, router, a peer device, a switch device or other common network node, would typically include many or all of the elements described in connection with the computer 1110. In a networked environment, program modules and data may be stored on the remote computer 1120. In a LAN and WAN environment the computer 1110 may use a telecommunication device such as a model or a network card to establish a connection. It will be appreciated that the network connections shown are illustrative and other devices of establishing a communications link between the computers may be used.

It may therefore be appreciated from the above detailed description of the preferred embodiment of the present invention that it provides a significant advance toward developing a more efficient mixed integer programming computing system.

Although an exemplary embodiment of the present invention has been shown and described with reference to particular embodiments and applications thereof, it will be apparent to those having ordinary skill in the art that a number of changes, modifications, or alterations to the present invention as described herein may be made, none of which depart from the spirit or scope of the present invention. All such changes, modifications, and alterations should therefore be seen as being within the scope of the present invention.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

### REFERENCES CITED

### OTHER REFERENCES

Aardal K., et al., “Solving a Linear Diophantine Equation with Lower and Upper Bounds on the Variables”, LANS vol. 1412, pp 229-242, 1998.
Aardal K., et al., “Solving a system of diophantine equation with lower and upper bounds on the variables”, Mathematics of Operations Research, vol. 25, pp 427-442, 2000.
Aardal K., et al., “Market Split and Basis Reduction: Towards a Solution of the Cornuéjols-Dawande Instances”, INFORMS Journal on Computing, 12, pp 192-202, 2000.
Aardal K., et al., “Non-standard approaches to integer programming”, Discrete Applied Mathematics, vol 123, pp 5-74, 2002.
Aardal K., et al., “Hard Equality constrained Integer Knapsacks”, Mathematics of Operations Research, vol 29(3), pp 724-738, 2004.
Anstreicher, K. M., “Towards A Practical Volumetric Cutting Plane Method for Convex Programming”, SIAM Journal of Optimization, vol 9(1), pp 190-206, 1998.
Anstreicher, K. M., “Ellipsoidal approximations of convex sets based on the volumetric barrier”, Mathematics of Operations Research, vol 24(1), pp 193-203, 1999.
Babai L., “On Lovász Lattice Reduction and The Nearest Lattice Point Problem”, Combinatorica, vol 6(1), pp 1-13, 1986.
Bazaraa, M. S., et al., “Nonlinear Programming Theory and Algorithms”, John Wiley, 1993.
Bertsimas, D., et al., “Introduction to Linear Optimization”, Athena Scientific, 1997.
Cassels, J. W. S., “An Introduction to the Geometry of Numbers”, Springer-Verlag, 1971.
Cook W., et al., “An implementation of the generalized basis reduction algorithm for integer programming”, ORSA Journal of Computing, vol 5, pp 206-215, 1993.
Cornuejols, G., et al., “A class of hard small 0-1 programs”, Lecture Notes in Computer Science, vol 1412, pp 284-293, 1998.
CPLEX, “CPLEX Callable Library”, Ilog, http://www.ilog.com/
Dakin, R. J., “A tree-search algorithm for mixed integer programming problems”, The Computer Journal, vol 8, pp 250-255, 1965.
Faybusovich, L., “Linear systems in Jordan algebras and primal-Dual interior point algorithms”, Journal of Computational and Applied Mathematics, vol 86, pp 149-175, 1997.
Gao, L., et al., “Computational Experience with Lenstra's Algorithm”, TR02-12, Department of Computational and Applied Mathematics, Rice University, 2002.
John, F., “Extremum problems with inequalities as subsidiary conditions”, in Studies and Essays, Presented to R. Courant on his 60th Birthday, Wiley Interscience, pp 187-204, 1948
Khachiyan, L. G, “Rounding of polytopes in the real number model of computation”, Mathematics Of Operations Research, vol 21(2), pp 307-320, 1996.
Khachiyan, L. G., et al., “On the complexity of approximating the maximal volume inscribed ellipsoid for a polytope”, Mathematical Programming, 61, 137-159, 1993.
Koy, H., et al., “Segment LLL-Reduction of Lattice Bases”, Lecture Notes in Computer Science, vol 2146, pp 67-80, 2001.
Land, A. H., et al., “An Automatic method for solving discrete programming problems”, Econometrica, vol 28, pp 497-520, 1960.
Lenstra, A. K., et al., “Factoring polynomials with rational coefficients”, Math. Ann., vol 261, pp 515-534, 1982.
Lenstra, H. W., “Integer programming with a fixed number of variables”, Mathematics of Operations Research, vol 8(4), pp 538-548, 1983.
Lovász, L., “An algorithmic theory of numbers, Graphs and Convexity”, SIAM, 1986.
Lovász, L., et al., “The generalized basis reduction algorithm,” Mathematics of Operations Research, vol 17(3), pp 751-764, 1992.
Mazzini, F. F., et al., “A mixed-integer programming model for the cellular telecommunication network design”, Proceedings of the 5th international workshop on Discrete algorithms and methods for mobile computing and communications, Rome, Italy, pp 68-76, 2001.
Mehrotra, S., et al., “Segment LLL Reduction of Latice Bases Using Modular Arithmetic”, IE/MS technical report 2004-14, Northwestern University, Evanston, Ill. 60208 (2004).
Mehrotra S., et al., “On Generalized Branching Methods for Mixed Integer Programming”, IEMS Technical Report 2004-15, Northwestern University, Evanston, Ill. 60208 (2004b).
Mehrotra, S., et al., “Finding an interior point in the optimal face of linear programs”, Mathematical Programming, vol 62, pp 497-515, 1993.
Nemhauser, G. L., et al., “Integer and Combinatorial Optimization”, John Wiley & Sons, 1988.
Nesterov, Y. E., et al., “Interior Point Polynomial Algorithms in Convex Programming”, SIAM Publications. SIAM, Philadelphia, USA, 1994
Renegar, J., “A Mathematical View of Interior-Point Methods in Convex Optimization”, MPS-SIAM series on Optimization, vol 40, pp 59-93, 2001
Schrijver, A., “Theory of linear and integer programming”, John-Wiley, 1986.
Stubbs, R., et al., “A Branch-and-cut method for 0-1 mixed convex programming”, Mathematical Programming, vol 86, pp 515-532, 1999.
Stubbs, R., et al., “Generating convex quadratic inequalities for mixed 0-1 programs”, Journal of Global Optimization, vol 24, pp 311-332 (2002).
Thomas, R., et al., “A Model-Based Optimization Framework for the Inference of Gene Regulatory Networks from DNA Array Data”, Bioinformatics, 20(17):3221-3235, 2004
Owen, J., et al., “Experimental Results on Using General Disjunctions in Branch-and-Bound For General-Integer Linear Programs”, Computational Optimization and Applications, vol 20(2), pp 159-170, 2001.
Vaidya, P. M. (1996), “A new algorithm for minimizing convex functions over convex sets”, Mathematical Programming, vol 73, pp 291-341, 1996.
Wang, X., “An Implementation of the Generalized Basis Reduction Algorithm for Convex Integer Programming”, Ph.D. dissertation, Department of Economics, Yale University, 1997.
Wolsey, L., “Integer Programming”, John Wiley & Sons, 1998.
Ye, Y., “On the convergence of interior-point algorithms for linear programming”, Mathematical Programming, vol 57, 325-335, 1992.

What is claimed is:

1. A method for finding a solution of a mixed integer program using a generalized-branch-and-cut tree, while generating branching hyperplane or half-spaces, and cutting planes, from integral adjoint lattice or kernel lattice bases of the coefficient matrix corresponding to the equality constraints.

2. The method of claim 1, further comprising,
finding a short nonzero vector from an integral adjoint lattice basis, where the length of the basis vector is measured under a suitably scaled projection, ellipsoidal, or generalized norm to compute a branching hyperplane or half-space in the original space using a lattice basis reduction method;
alternatively, finding a short nonzero vector from the identity lattice basis, or Kernel, or dual lattice basis, where the length of the vector is measured under an ellipsoidal norm, and subsequently multiplying this short vector with the integral adjoint lattice basis matrix to compute a branching hyperplane or half-space in the original space using a lattice basis reduction method;
alternatively, finding a short nonzero vector from a dual lattice basis, where the length of the basis vector is measured under a suitable scaled projection, ellipsoidal, or generalized norm compute a branching hyperplane or half-space in the original space using a lattice basis reduction method;
using a hierarchical approach with proper safeguards to using increasingly computationally expensive methods as desired with proper safeguards for computing the branching hyperplanes or half-spaces.

3. The method of claim 1, further comprising,
rounding a continuous solution to a feasible or infeasible mixed integer solution by taking the difference of this continuous solution with an infeasible mixed integer solution, writing the integer components of this difference using linear combination of vectors of kernel lattice, rounding the coefficients of this linear combination, forming a vector by adding the kernel lattice basis vectors after multiplying them with the rounded coefficients, adding this vector to the integer components of the infeasible mixed integer solution to get the integer segment of the rounded solution, and subsequently restoring the continuous components of the rounded solution by using the solution of a continuous optimization problem;

4. The method of claim 1, further comprising,
using integral adjoint lattice basis vectors to define a cut generation problem as a disjunctive program;

5. The method of claim 1, further comprising,
for problems with mixed integer variables, putting the original equality constraint matrix in a form that has as many linearly independent rows as possible whose coefficients corresponding to the continuous variables are all zero, and representing this set of rows by A;
computing the kernel lattice Z and/or the integral adjoint lattice Z* of A by using a unimodular matrix U such that AU gives the Hermite-Normal-Form of A, then subsequently using trailing columns of U to form Z, and corresponding rows of U⁻¹ to form Z*.

6. The method of claim 1, further comprising,
approximating the integral adjoint or the kernel lattice with another bigger lattice, which is either an identity matrix, or is obtained by taking an integer multiple of the original lattice;
approximating the integral adjoint or the kernel lattice with another smaller lattice, which is either formed by taking a subset of columns from the original lattice basis vectors, or is obtained by taking an integer division of the original lattice basis vectors and subsequently rounding elements of these vectors to their nearest coefficient value;
approximating integral adjoint lattice or by taking a set of solutions taking fractional values at the optimum of the continuous relaxation problem and properly augmenting this set;

7. The method of claim 1, further comprising,
taking the objective function of the problem in the original mixed integer programs and possibly writing it as an inequality constraint;
adding a new variable with a suitably large penalty to ensure feasibility;

8. The method of claim 1, further comprising,
using a solution of the cut generation disjunctive program in claim 1 generating and adding valid linear or convex inequality constraints (cuts) while not changing the mixed integer feasible solution set of the mixed integer program under consideration;

9. The method of claim 1, further comprising,
explicitly or implicitly removing any variables from the problem whose optimum value is known;

10. The method of claim 1, further comprising,
identifying a subset (possibly empty) of constraints, removing these constraints from the original problem, generating a set of feasible solutions of the structured constraints, and replacing the variables corresponding to these solutions through their convex hull in the mixed integer programming problem.

11. The method of claim 1, further comprising,
developing a generalized-branch-and-cut tree and seeding the tree with a root node;

12. The method of claim 1, further comprising,
solving a continuous convex relaxation of the problem at the root or other nodes of the branch-cut-and-price tree, and identify the dual multipliers of this continuous convex relaxation;
updating the global lower bound if no solutions of the subproblem can improve the objective value of the master problem;

13. The method of claim 1, further comprising,
computing a center point of the continuous convex relaxation and a positive definite matrix to define an ellipsoidal approximation of the continuous relaxation of a portion or the entire feasible region;
using a barrier function, possibly a self-concordant barrier function, on the inequality constraints and maximize this barrier to find a center point and an ellipsoidal approximation of the feasible set of the root node mixed integer program,
using a primal or primal-dual interior point method for maximizing the barrier function;
using a volumetric barrier to approximate the convex set when self-concordant barriers are not available, and general log-barrier does not give good performance.

14. The method of claim 1, further comprising,
computing a Lenstra-Lenstra-Lovász-reduced, or Segment-reduced, or some such reduced (exact or approximate) integral adjoint lattice basis under a norm defined by a scaled projection matrix by using improvements of Lenstra-Lenstra-Lovász basis reduction algorithms or the segment-reduction algorithms for the scaled projected norm, or find a Lovász-Scarf-reduced basis of the (exact or approximate) integral adjoint lattice basis under a norm defined by a convex relaxation of the mixed integer problem at the root node using

15. The method of claim 1, further comprising,
computing a Segment-reduced, or Lenstra-Lenstra-Lovász-reduced, or some such reduced (exact or approximate) kernel lattice basis under a norm defined by a positive definite matrix giving the ellipsoidal approximation of the feasible region, or the Lovász-Scarf-reduced basis of the (exact or approximate) kernel lattice basis under a norm defined suitably using a convex relaxation of the mixed integer problem at the root node using Lovász-Scarf basis reduction algorithm or some such algorithm.

16. The method of claim 1, further comprising,
using the reduced kernel lattice basis from claim 13 to round an available solution to a mixed integer solution using the method from claim 2 in the original space;
additionally using other available methods to round an available solution to a mixed integer solution in the original space;

17. The method of claim 1, further comprising,
checking the feasibility of rounded solutions available in claim 15 for all the constraints of the mixed integer program, if feasible then upper bound is updated, and a constraint is added ensuring that solutions with values larger than this upper bound are removed;

18. The method of claim 1, further comprising,
stopping if the difference between the lower bound and upper bound is within specified tolerance, or if the the given time limit has exceeded;

19. The method of claim 1, further comprising,
dividing the problem at a selected node into subproblems by adding general hyperplanes and/or half-spaces to the selected node using an exact or approximate lattice basis;
adding the new problems as nodes to the existing branch-cut-and-price tree.

20. The method of claim 1, further comprising,
selecting a node from a given generalized-branch-and-cut tree for further processing using methods such as depth first search, or best-node first, or a combination strategies;

21. The method of claim 1, further comprising,
recursively using the methods in the system at each selected node of the generalized-branch-and-cut tree.

22. The method of claim 1, further comprising,
an option selection method and system to choose from a menu of possible methods;
a tree storage and management method and system to keep information on the generalized-branch-and-bound tree;
a communication method and system to maintain consistent information across all nodes of the tree;
a message passing method and system for passing messages among different processing units if multiple computer processing units are used at a local computer or at computers located on an internet or intranet.

23. The method of claim 1, further comprising,
a method and system to allow the end user to make their own option selections to control the execution flow of the system;
a method and system to allow an end user to provide their own methods and systems to plug-and-compute to further improve the efficiency;

24. A computing system for Method of claim 1, wherein the system includes one or plurality of computers, and computer readable, compilable, and executable program codes for performing the step of:
reading input data, writing and displaying output;
exact adjoint lattice basis computation;
kernel lattice basis computation;
dual lattice basis computation;
segment basis reduction of a lattice in an appropriate norm;
Lenstra, Lenstra, Lovász basis reduction of a lattice in an appropriate norm;
Generalized basis reduction of a lattice;
making approximation to a lattice;
converting a mixed integer program to a mixed integer program with linear objective;
finding a center and an ellipsoid approximating the continuous relaxation of selected node;
solving a continuous relaxation;
rounding a continuous solution to an integer solution;
computing the branching hyperplane;
hierarchical basis reduction logic to select the correct basis reduction method;
adding a node to the branch-and-cut tree;
deleting a node from the branch-and-cut tree;
updating lower and upper bounds;
making selections from given method choices;
allowing user to provide their own methods and systems to plug-and-compute;
communicating information on the branch-and-cut tree;
passing messages among different processing units located and connected locally or remotely, the step of termination checks, and so on.
